(19) United States
(12) Patent Application Publication
(10) Pub. No.: US 2023/0194387 A1
(43) Pub. Date: Jun. 22, 2023

(54) DEVICE FOR TESTING OF AN ENVIRONMENTAL SAMPLE

(71) Applicant: Becton, Dickinson and Company, Franklin Lakes, NJ (US)

(72) Inventors: Adam MARTIN, Holly Springs, NC (US); Melody KURODA, Durham, NC (US); Alexander G. LASTOVICH, Gilbert, AZ (US); Eric FALLOWS, Apex, NC (US); Scott CASTANON, Carlsbad, CA (US); Isabel SIMONS, Oceanside, CA (US)

(21) Appl. No.: 18/172,685

(22) Filed: Feb. 22, 2023

Related U.S. Application Data
(63) Continuation of application No. PCT/US2021/049596, filed on Sep. 9, 2021.
(60) Provisional application No. 63/077,490, filed on Sep. 11, 2020.

(51) Int. Cl. G01N 1/02; B01L 3/00

(52) U.S. Cl. CPC G01N 1/02; B01L 3/502738; B01L 3/52; B01L 3/502715; B01L 2200/0621; B01L 2300/042; B01L 2300/1827; B01L 2400/0638; G01N 2001/028; B01L 2300/0816; B01L 2200/10; B01L 2200/0689

(57) ABSTRACT

Detection devices, systems, and methods for detecting an analyte in a fluid sample are provided. The detection devices, systems, and methods can include colorimetric detection to rapidly determine the presence and/or quantity of the analyte obtained from a surface that is contaminated or suspected of being contaminated with the analyte. In one aspect, the detection device includes a sample reservoir in fluid communication with a fluid flow path. The fluid flow path includes a control well downstream of the sample reservoir, a valve assembly downstream of the control well, a reagent well downstream of the valve assembly, and a test well downstream of the reagent well. In one aspect, the reagent well includes a dried reducing agent configured to generate a gas in the presence of a detection dye and the analyte in the fluid sample.

### CROSS REFERENCE TO RELATED APPLICATION

This application is a continuation of PCT Application No. PCT/US2021/049596, filed Sep. 9, 2021, which claims the benefit of U.S. Provisional Application No. 63/077,490, filed Sep. 11, 2020, each of which is hereby incorporated by reference in its entirety.

### FIELD

The present disclosure relates in general to detection devices, test systems, and methods. More particularly, the present disclosure relates to detection devices, including colorimetric detection devices, having a fluid flow path including one or more of a control well, a valve assembly, a reagent well, and a test well to detect the presence and/or quantity of an analyte in a sample.

### BACKGROUND

Antineoplastic drugs are used to treat cancer, and are often found in a small molecule (like fluorouracil) or antibody format (like Rituximab). Detection of antineoplastic drugs is critical for determining if there is contamination or leakage where the drugs are used and/or dispensed, such as hospital and pharmacy areas.

The nature of antineoplastic drugs make them harmful to healthy cells and tissues as well as the cancerous cells. Precautions should be taken to eliminate or reduce occupational exposure to antineoplastic drugs for healthcare workers. Pharmacists who prepare these drugs and nurses who may prepare and administer them are the two occupational groups who have the highest potential exposure to antineoplastic agents. Additionally, physicians and operating room personnel may also be exposed through the treatment of patients, as patients treated with antineoplastic drugs can excrete these drugs. Hospital staff, such as shipping and receiving personnel, custodial workers, laundry workers and waste handlers, all have the potential to be exposed to these drugs during the course of their work. The increased use of antineoplastic agents in veterinary oncology also puts these workers at risk for exposure to these drugs.

### SUMMARY

Antineoplastic drugs are antiproliferative. In some cases they affect the process of cell division by damaging DNA and initiating apoptosis, a form of programmed cell death. Although this can be desirable for preventing development and spread of neoplastic (e.g., cancerous) cells, antineoplastic drugs can also affect rapidly dividing non-cancerous cells. As such, antineoplastic drugs can suppress healthy biological functions including bone marrow growth, healing, hair growth, and fertility, to name a few examples.

Studies have associated workplace exposures to antineoplastic drugs with health effects such as skin rashes, hair loss, infertility (temporary and permanent), effects on reproduction and the developing fetus in pregnant women, increased genotoxic effects (e.g., destructive effects on genetic material that can cause mutations), hearing impairment and cancer. These health risks are influenced by the extent of the exposure and the potency and toxicity of the hazardous drug. Although the potential therapeutic benefits of hazardous drugs may outweigh the risks of such side effects for ill patients, exposed health care workers risk these same side effects with no therapeutic benefit. Further, it is known that exposures to even small concentrations of antineoplastic drugs may be hazardous for workers who handle them or work near them, and for known carcinogenic agents there is no safe level of exposure.

Embodiments of detection devices according to the present disclosure can detect the presence, absence, or quantity of an analyte in an environmental sample on-location. Although embodiments of the present disclosure will be explained in the context of detecting an analyte that is an antineoplastic agent, embodiments of the present disclosure can be implemented to detect any suitable analyte of interest. Results of the test can be provided quickly and on-site, such that the operator of the test, other personnel in the area, and/or remote personnel can be alerted to the presence and/or concentration of antineoplastic agents close in time to the test event. Methods of testing include obtaining a sample from a surface that is contaminated or suspected of being contaminated with an antineoplastic agent. The sample can be obtained, for example, by contacting the surface with a buffer solution and wiping the surface with an absorbent swab, or by wiping the surface with a swab pre-wetted with the buffer solution. The collected contaminants (analyte) can be mixed into a solution for testing. The buffer solution, together with any collected contaminants, can be expressed or extracted from the swab to form a liquid sample. This liquid sample can be analyzed for presence and/or quantity of specific antineoplastic agents. For example, the liquid sample can be added to the detection devices described herein, and the detection device can then be read by a user or placed into a test system, such as a reader device, to identify the presence and/or a concentration of the analyte in the liquid sample.

Some embodiments disclosed herein relate to detection devices for detecting an analyte in a fluid sample. In some embodiments, the detection devices include a sample reservoir in fluid communication with a fluid flow path. In some embodiments, the fluid flow path includes a control well downstream of the sample reservoir, a valve assembly downstream of the control well, a reagent well downstream of the valve assembly, the reagent well comprising a reducing agent dried therein, and a test well downstream of the reagent well.

In some embodiments, the reducing agent is configured to react with a detection dye in the presence of analyte to initiate a color change. In some embodiments, the reducing agent is configured to generate a gas in the reagent well when the analyte is present in the fluid sample, the gas generated in the reagent well configured to propel the fluid sample from the reagent well into the test well. In some embodiments, the reducing agent is NaBH₄.

In some embodiments, the valve assembly includes a one-way valve configured to allow the fluid sample and the gas generated in the reagent well to move from the reagent well towards the test well, and to prevent the fluid sample and the gas generated in the reagent well from moving upstream of the one-way valve.

In some embodiments, the sample reservoir includes a detection dye dried therein. In some embodiments, the detection dye is configured to solubilize into the fluid sample when the fluid sample is added to the sample reservoir, and wherein the reducing agent is configured to react with the solubilized detection dye when the analyte is present in the fluid sample. In some embodiments, the fluid flow path includes a mixing feature downstream of the sample reservoir, and the mixing feature can include a plurality of posts disposed in the fluid flow path. In some embodiments, the plurality of posts are configured to promote mixing of the fluid sample with the detection dye when the fluid sample is added to the sample reservoir. In some embodiments, the detection dye is direct red 2, direct red 7, direct red 13, direct red 53, direct red 75, direct red 80, direct red 81, direct fast red B, methylene blue, methyl orange, crocein scarlet 7B, Congo red, or an azo dye. In some embodiments, the analyte is a platinum-based antineoplastic drug, including cisplatin, carboplatin, oxaliplatin, nedaplatin, triplatin tetranitrate, ormaplatin, phenanthriplatin, picoplatin, pyriplatin, or satraplatin, or analogues or derivatives thereof.

In some embodiments, the detection devices further include an overflow reservoir arranged concentrically around the sample reservoir. In some embodiments, the detection devices further include a cap, wherein the cap comprises an outer seal and an activation plunger comprising an inner seal. In some embodiments, the activation plunger is configured to sealably couple with the sample reservoir, and configured to propel a precise, predetermined volume of fluid sample through the fluid flow path. In some embodiments, the detection devices further include a gas vent downstream of the test well, wherein the gas vent is configured to allow gas in the fluid flow path to evacuate the device after the fluid sample is added to the sample reservoir and begins to flow in the fluid flow path. In some embodiments, the gas vent includes a frit configured to seal to the passage of gas and the fluid sample in the presence of the fluid sample.

In some embodiments, the detection devices further include a top substrate having portions of the fluid flow path and a bottom substrate comprising portions of the fluid flow path, wherein the fluid flow path further comprises a plurality of junction points when the top substrate is coupled to the bottom substrate, the plurality of junction points configured to move the fluid sample between the top substrate and the bottom substrate as the fluid flows from the sample reservoir to the test well.

In some embodiments, the detection devices further include a housing comprising a viewing window positioned above a top surface of the test well and a top surface of the control well, wherein optical signals read through the viewing window from the test well are different than optical signals read through the viewing window from the control well when the analyte is present in the fluid sample.

In some embodiments, the detection devices further include a heating element substrate comprising a heat activation reservoir, wherein a top surface of the heat activation reservoir is generally coplanar with the top surface of the test well and the top surface of the control well, the housing further comprising an access window positioned above the top surface of the heat activation reservoir, the heat activation reservoir configured to receive an activation agent through the access window. In some embodiments, the heating element substrate further includes a heating element cavity positioned below the test well and the control well, the heating element cavity comprising an exothermic heating material configured to generate heat when exposed to the activation agent is added to the heat activation reservoir. In some embodiments, the detection devices further include a wicking paper comprising a first portion positioned in the heat activation reservoir and a second portion positioned in the heating element cavity, the wicking paper configured to wick at least a portion of the activation agent added to the heat activation reservoir into the heating element cavity. In some embodiments, the heat activating agent is air, water, buffer, or a fluid, and wherein the exothermic heating material comprises magnesium, iron, calcium chloride, calcium oxide, sodium acetate, paraffin, a salt hydrate, a fatty acid, other phase change material, or combinations thereof. In some embodiments, the detection devices further include a resistive heating element comprising a printed circuit board and an external power connector, the printed circuit board comprising a plurality of resistive heaters positioned below the reagent well, the test well, and the control well.

Some embodiments disclosed herein relate to methods of detecting an analyte in a fluid sample. In some embodiments the methods include applying the fluid sample to the sample reservoir of a detection device, solubilizing a detection dye in the sample reservoir into the fluid sample, propelling the fluid sample and the detection dye through the fluid flow path by coupling a cap to the sample reservoir, wherein the fluid sample and the solubilized detection dye flow sequentially to the control well, through the valve assembly, and to the reagent well, and generating a gas in the reagent well when the analyte is present in the fluid sample, wherein the gas generated in the reagent well propels the fluid sample from the reagent well into the test well. In some embodiments, the detection device includes a sample reservoir in fluid communication with a fluid flow path. In some embodiments, the fluid flow path includes a control well downstream of the sample reservoir, a valve assembly downstream of the control well, a reagent well downstream of the valve assembly, the reagent well comprising a reducing agent dried therein, and a test well downstream of the reagent well.

In some embodiments, the reducing agent in the reagent well reacts with the solubilized detection dye in the fluid sample in the presence of the analyte in the fluid sample, initiating a color change in the fluid sample that is detectable in the test well.

In some embodiments, the methods further include mixing the fluid sample and the detection dye using a mixing feature positioned in the fluid flow path downstream of the sample reservoir. In some embodiments, the methods further include measuring a control signal at the control well, measuring a test signal at the test well, and indicating to a user that the analyte is not present in the fluid sample based on a determination that that the control signal and the test signal are substantially the same. In some embodiments, the methods further include measuring a control signal at the control well, measuring a test signal at the test well, and indicating to a user that the analyte is present in the fluid sample based on a determination that that the control signal and the test signal are different.

In some embodiments, the control signal is an optical signal having a first color and the test signal is an optical signal having a second, different color, wherein the fluid sample emits the optical signal having the second, different color as a result of a reduction of the detection dye in the presence of the reducing agent and the analyte. In some embodiments, the detection dye is configured the change from the first color to the second, different color in the presence of the reducing agent and the analyte. In some embodiments, the reducing agent is NaBH₄. In some embodiments, the fluid sample is applied to the sample reservoir in an amount of 100 to 500 μL. In some embodiments, the fluid sample is applied to the sample reservoir in an amount of about 250 μL. In some embodiments, the analyte is a platinum-based antineoplastic drug. In some embodiments, the platinum-based antineoplastic drug comprises cisplatin, carboplatin, oxaliplatin, nedaplatin, triplatin tetranitrate, ormaplatin, phenanthriplatin, picoplatin, pyriplatin, or satraplatin, or analogues or derivatives thereof. In some embodiments, the methods further include heating the reagent well and the test well with a heating element disposed below the reagent well and the test well. In some embodiments, heating the reagent well and the test well includes exposing an exothermic heating material disposed below the reagent well and the test well to a heat activating agent. In some embodiments, the methods further include adding the heat activating agent to a heat activation reservoir of the detection device, and moving the heat activating agent from the heat activation reservoir to a cavity comprising the exothermic heating material. In some embodiments, the methods further include obtaining or having obtained a fluid sample from a surface that is contaminated or suspected of being contaminated with the analyte.

Some embodiments provided herein relate to test systems. In some embodiments, test systems include a detection device for detecting an analyte in a fluid sample, a reader comprising a light source and a detector, and a data analyzer. In some embodiments, the detection device includes a sample reservoir in fluid communication with a fluid flow path. In some embodiments, the fluid flow path includes a control well downstream of the sample reservoir, a valve assembly downstream of the control well, a reagent well downstream of the valve assembly, the reagent well comprising a reducing agent dried therein, and a test well downstream of the reagent well. In some embodiments, the data analyzer is configured to output an indication that the analyte is not present in the fluid sample when the reader detects that a control signal measured at the control well is substantially the same as a test signal measured at the test well. In some embodiments, the data analyzer is configured to output an indication that the analyte is present in the fluid sample when the reader detects that a control signal measured at the control well is different than a test signal measured at the test well.

Some embodiments provided herein relate to detection devices for detecting an analyte in a fluid sample. In some embodiments the detection devices include a sample reservoir in fluid communication with a fluid flow path, wherein the fluid flow path comprises a control well downstream of the sample reservoir; a reagent well downstream of the control well, the reagent well comprising a reducing agent dried therein; a test well downstream of the reagent well; and a one-way valve downstream of the control well and upstream of the reagent well, the one-way valve oriented to allow the fluid sample to pass from the control well toward the reagent well and to prevent the fluid sample from moving upstream of the one-way valve.

In some embodiments, the detection device further comprises a top substrate comprising portions of the fluid flow path and a bottom substrate comprising portions of the fluid flow path. In some embodiments, the one-way valve is disposed at a junction point where the top substrate is coupled to the bottom substrate along the fluid flow path. In some embodiments, the control well and the reagent well are disposed at least partially within the bottom substrate. In some embodiments, the fluid flow path traverses a plurality of junction points where the top substrate is coupled to the bottom substrate.

In some embodiments, the one-way valve is disposed at a third junction point along the fluid flow path. In some embodiments, the one-way valve comprises a flapper valve having a normally closed configuration. In some embodiments, the flapper valve is oriented such that a fluid or gas pressure in a downstream direction along the fluid flow path causes the flapper valve to move to an open configuration and such that a fluid or gas pressure in an upstream direction along the fluid flow path causes the flapper valve to seal against an inlet of the valve. In some embodiments, the flapper valve comprises an elastomeric element disposed between two substrate layers of the detection device. In some embodiments, the elastomeric element comprises a support ring and a displacement flapper, the displacement flapper positioned to be displaced at least partially into a flapper relief cavity in the presence of a downstream fluid pressure.

In some embodiments, the detection device further comprises a cap, wherein the cap comprises an outer seal and an activation plunger comprising an inner seal. In some embodiments, the activation plunger is configured to sealably couple with the sample reservoir, and configured to propel a precise volume of fluid sample through the fluid flow path. In some embodiments, sealably coupling the activation plunger with the sample reservoir generates a fluid pressure within the fluid sample sufficient to cause the one-way valve to move to an open configuration.

In some embodiments, the reducing agent is configured to react with a detection dye in the presence of the analyte to initiate a color change. In some embodiments, the detection dye is located in the sample reservoir before the fluid sample is added to the detection device, and the detection dye is configured to initiate the change from a first color to a second, different color in the presence of the reducing agent and the analyte. In some embodiments, the reducing agent is configured to generate a gas in the reagent well when the analyte is present in the fluid sample, the gas generated in the reagent well configured to propel the fluid sample from the reagent well into the test well.

In some embodiments, the detection device further comprises a housing comprising a viewing window positioned above a top surface of the test well and a top surface of the control well, wherein optical signals read through the viewing window from the test well are different than optical signals read through the viewing window from the control well when the analyte is present in the fluid sample. In some embodiments, the detection device further comprises a heating element substrate comprising a heat activation reservoir, wherein the housing further comprises an access window positioned above a top surface of the heat activation reservoir, the heat activation reservoir configured to receive an activation agent through the access window. In some embodiments, the heating element substrate further comprises a heating element cavity positioned below the test well and the control well, the heating element cavity comprising an exothermic heating material configured to generate heat when exposed to the activation agent added to the heat activation reservoir. In some embodiments, the detection device further comprises a wicking paper comprising a first portion positioned in the heat activation reservoir and a second portion positioned in the heating element cavity, the wicking paper configured to wick at least a portion of the activation agent added to the heat activation reservoir into the heating element cavity.

In some embodiments, the detection device further comprises a resistive heating element comprising a printed circuit board and an external power connector, the printed circuit board comprising a plurality of resistive heaters positioned below the reagent well, the test well, and the control well. In some embodiments, the analyte is a platinum-based antineoplastic drug. In some embodiments, the platinum-based antineoplastic drug comprises cisplatin, carboplatin, oxaliplatin, nedaplatin, triplatin tetranitrate, ormaplatin, phenanthriplatin, picoplatin, pyriplatin, or satraplatin, or analogues or derivatives thereof.

Some embodiments provided herein relate to detection devices for detecting an analyte in a fluid sample. In some embodiments, the detection devices include a sample reservoir in fluid communication with a fluid flow path. The fluid flow path includes a reagent well comprising a reducing agent dried therein, a test well downstream of the reagent well, and an overflow well downstream of the test well, the overflow well including a gas vent. The detection device further includes an overflow reservoir arranged concentrically around the sample reservoir.

In some embodiments, the detection device further comprises a cap configured to cover the sample reservoir and the overflow reservoir. In some embodiments, the cap comprises an activation plunger configured to sealably couple with the sample reservoir. In some embodiments, the sample reservoir is at least partly defined by a reservoir wall, and the activation plunger comprises a circumferential seal having a size and shape corresponding to a size and shape of an interior of the reservoir wall. In some embodiments, sealably coupling the activation plunger with the sample reservoir pressurizes and propels a pre-determined volume of fluid from the sample reservoir into the fluid flow path. In some embodiments, the pre-determined volume corresponds to a total volume of fluid within the fluid flow path. In some embodiments, sealably coupling the activation plunger with the sample reservoir displaces, from the sample reservoir into the overflow reservoir, any portion of a fluid sample within the sample reservoir exceeding a pre-determined volume. In some embodiments, the cap further comprises an outer seal sized and shaped to engage with the overflow reservoir to retain fluid within the overflow reservoir when the cap covers the overflow reservoir. In some embodiments, closing the cap sealably isolates the overflow reservoir from the fluid flow path and from an exterior of the detection device.

In some embodiments, the analyte is a platinum-based antineoplastic drug. In some embodiments, the platinum-based antineoplastic drug comprises cisplatin, carboplatin, oxaliplatin, nedaplatin, triplatin tetranitrate, ormaplatin, phenanthriplatin, picoplatin, pyriplatin, or satraplatin, or analogues or derivatives thereof.

In some embodiments, the gas vent is configured to allow gas in the fluid flow path to evacuate the detection device after the fluid sample is added to the sample reservoir and begins to flow in the fluid flow path. In some embodiments, the gas vent comprises a frit configured to seal to the passage of gas and the fluid sample in the presence of the fluid sample.

In some embodiments, the reducing agent is configured to react with a detection dye in the presence of the analyte to initiate a color change. In some embodiments, the detection dye is located in the sample reservoir before the fluid sample is added to the detection device, and wherein the detection dye is configured the change from a first color to a second, different color in the presence of the reducing agent and the analyte. In some embodiments, the reducing agent is configured to generate a gas in the reagent well when the analyte is present in the fluid sample, the gas generated in the reagent well configured to propel the fluid sample from the reagent well into the test well.

In some embodiments, the fluid flow path further comprises a control well downstream of the sample reservoir and the detection device further comprises a housing comprising a viewing window positioned above a top surface of the test well and a top surface of the control well, wherein optical signals read through the viewing window from the test well are different than optical signals read through the viewing window from the control well when the analyte is present in the fluid sample. In some embodiments, the detection device further comprises a heating element substrate comprising a heat activation reservoir, wherein the housing further comprises an access window positioned above a top surface of the heat activation reservoir, the heat activation reservoir configured to receive an activation agent through the access window. In some embodiments, the heating element substrate further comprises a heating element cavity positioned below the test well and the control well, the heating element cavity comprising an exothermic heating material configured to generate heat when exposed to the activation agent added to the heat activation reservoir. In some embodiments, the detection device further comprises a wicking paper comprising a first portion positioned in the heat activation reservoir and a second portion positioned in the heating element cavity, the wicking paper configured to wick at least a portion of the activation agent added to the heat activation reservoir into the heating element cavity.

In some embodiments, the detection device further comprises a resistive heating element comprising a printed circuit board and an external power connector, the printed circuit board comprising a plurality of resistive heaters positioned below the reagent well, the test well, and the control well.

Some embodiments provided herein relate to methods of testing a fluid sample using a detection device. In some embodiments, the methods include applying the fluid sample to a sample reservoir of a detection device, the fluid sample having a volume greater than or equal to a pre-determined volume. The detection device includes the sample reservoir; a fluid flow path in communication with the sample reservoir, the fluid flow path comprising at least a reagent well comprising a reducing agent dried therein and a test well downstream of the reagent well; an overflow reservoir arranged concentrically around the sample reservoir; and a cap comprising an activation plunger sized and shaped to sealably engage within the sample reservoir. In some embodiments, the method further includes engaging the cap with the sample reservoir and applying a pressure on the cap to propel the pre-determined volume of the fluid sample into the fluid flow path.

In some embodiments, applying the pressure on the cap simultaneously displaces, from the sample reservoir into the overflow reservoir, any portion of the fluid sample exceeding the pre-determined volume. In some embodiments, applying the pressure on the cap causes an outer seal of the cap to engage with a wall of the overflow reservoir to prevent leakage of the fluid sample from the detection device. In some embodiments, the detection device further comprises a resistive heating element, and wherein applying the pressure on the cap causes the cap to activate a mechanical switch that activates the resistive heating element.

### BRIEF DESCRIPTION OF THE DRAWINGS

FIGS. 1A and 1B illustrate a top view of an example detection device according to the present disclosure. In FIG. 1A, a cap is in the open position, exposing a sample reservoir. In FIG. 1B, the cap is in the closed position.

FIG. 2 illustrates a cross-sectional view of sample volume collection control features of the example detection device of FIG. 1A.

FIG. 3 illustrates an exploded view of the example detection device of FIG. 1A.

FIGS. 4A and 4B illustrate top views of a fluid flow path in the example detection device of FIG. 1A in the absence of a fluid sample (FIG. 4A) and in the presence of a fluid sample (FIG. 4B).

FIG. 5 illustrates an exploded view of components of the example detection device of FIG. 1A.

FIG. 6A illustrates a top perspective view of the top substrate and the bottom substrate of the example detection device of FIG. 1A. FIG. 6B illustrates a bottom perspective view of the top substrate and the bottom substrate of the example detection device of FIG. 1A.

FIG. 7A illustrates an elastomeric element of a one-way valve of the example detection device of FIG. 1A. FIG. 7B illustrates a cross-sectional view of the top substrate, the one-way flapper valve, and the bottom substrate of the example detection device of FIG. 1A.

FIGS. 8A-8C illustrate integral heating features of example detection device of the present disclosure. FIG. 8A illustrates an exploded view of depicts an exploded view of components of an integral chemical heating element of the example detection device of FIG. 1A. FIG. 8B depicts an example integral electrical heating feature of another example detection device of the present disclosure. FIG. 8C depicts the integral electrical heating feature separate from a housing of the example detection device of FIG. 8B.

### DETAILED DESCRIPTION

Embodiments of the disclosure relate to detection devices, test systems, and methods for measuring an analyte. Embodiments of the detections devices, systems, and methods provide several advantages over existing devices, systems, and methods. For example, the present devices deliver a specified and required volume of fluid sample to the detection device, without the need for the user to pre-measure a volume of fluid sample prior to contacting the device with the fluid sample. Thus, the sample volume is automatically controlled, and the user does not have to measure the sample volume, thereby eliminating or reducing user error. Additional advantages include pressure-driven fluid flow without requiring external, specialized equipment to propel a sample through a fluid flow path; isolation of a control region of a fluid flow path from a test region of the same fluid flow path; a fluid flow path that is provided in two separate substrates and includes a one-way valve to reduce artifacts in the control and test regions; and integral heating features to control or accelerate assay development. These and other advantages will be discussed in detail in the following detailed description.

Platinum-based drugs are commonly used to treat patient-oncologic malignancies through infusion, such as in lung, gastrointestinal, breast, and gynecologic cancers. Primary test sites are associated with infusion solution preparation spaces. Ease-of-use and access allow for testing of infusion locations and other monitoring sites of concern. Testing may be used to validate decontamination procedures, monitor drug preparation methods, or assess environmental contamination. The methods, systems, and devices disclosed herein enable on-location analysis, sample, and testing for immediate results with minimal turn-around and reduced cost.

### Sample Collection Volume Control

Embodiments of the detection device can include sample collection volume control features. These features advantageously allow an operator to fill a reservoir with a fluid sample, eliminating the need to measure a precise volume of fluid sample before adding the fluid sample to the detection device. For example, a user need not pipette a precise volume or fluid sample into the detection device nor count a number of drops of fluid sample being added to the detection device. Volume control features include a sample reservoir surrounded by an overflow reservoir. The sample reservoir is sized to provide a pre-determined volume of sample into the detection device, with any excess fluid being captured by the surrounding overflow reservoir. Volume control features also include a cap with a plunger component. Capping the sample reservoir with the cap advantageously accomplishes three separate functions: (1) causing excess fluid to be moved from the sample reservoir to the overflow reservoir; (2) propelling a precise, predetermined volume of fluid sample into a fluid flow path of the detection device; and (3) sealing the sample reservoir and the overflow reservoir to prevent fluid (which may contain a hazardous contaminant) from inadvertently escaping the device.

### Fluid Flow Paths Including Internal Pressure Generation and Artifact Reduction

Optical systems that determine the presence or concentration of colored compounds in solution (colorimetry) are sensitive to artifacts in the test reading area. Undesirable artifacts can include bubbles and debris. Embodiments of the detection device can include a fluid flow path and wells that are advantageously configured to reduce artifacts that can interfere with detecting an analyte of interest in the test reading area, in this case a test well. The detection devices can include a control well that can be fluidically isolated from a test well; an internal, self-contained source of gas pressure that provides a driving force to propel a fluid sample within the fluid flow path; a one-way valve that prevents the fluid sample from backflowing through the fluid flow path after the gas pressure is generated; fluid flow path features that reduce the formation of bubbles in wells, including the test well; or any combination of these advantageous features. Features that reduce the formation of bubbles include a fluid flow path that fills wells from a bottom of the well, and a self-sealing vent that allows gas in the fluid flow path to exit the detection device as the fluid sample flows through the fluid flow path. Additional features that reduce the presence of bubbles in the test well include surface modifications of sidewalls of a well where gas is generated to promote adhesion, and surface modifications of sidewalls of the test well to promote wetting. In one example, as gas is generated in a designated reaction well, bubbles are formed and tend to adhere to the surface-modified sidewalls of the reaction well. This adhesion prevents or minimizes bubbles from migrating into a downstream test well with the fluid sample. Volumetric expansion of the gas in the reaction well allows the fluid sample to migrate relatively bubble-free into the test well, whose sidewalls can also be treated to promote wettability. Fluid sample moved into the test well in this manner can be relatively free of artifacts for clearer imaging in the test well.

Advantageously, the fluid sample itself flowing through the fluid flow path can reconstitute a dye and a reducing agent. The reconstituted dye is used in a colorimetric detection of an analyte of interest in the fluid sample, if present. Reconstituting the reducing agent in a reaction well generates air or gas pressure to move the fluid sample to a test well, where a physical characteristic, such as a color, of a test portion of the initial fluid sample can be compared to a physical characteristic, such as a color, of a control portion of the same initial fluid sample. Filling the test well using internally-generated air or gas pressure in this manner can prevent large bubbles from forming in the test well, thereby enhancing imaging of assay results. Filling the test well using internally-generated air or gas pressure in this manner can also allow for lower sealing pressure requirements. For example, components forming the fluid flow path can be sealed together using mechanisms having relatively low fluid pressure tolerances compared to prior systems.

In one non-limiting embodiment of the present disclosure, a fluid sample is added to a collection well or sample reservoir of a detection device. The collection well can include various sample collection volume control features described above, and in more detail below. The fluid sample in the collection well reconstitutes a dried dye present in the collection well. The fluid sample is driven through a mixing feature and into a control well, through a one-way valve, and into a reaction well. The mixing feature can enhance mixing of the reconstituted dye with the fluid sample. The fluid sample in the reaction well reacts with a dried agent present in the reaction well, generating a gas. The dried agent can include a dried reducing agent, such as but not limited to dried NaBH₄. Formation of gas in the reaction well forces the fluid sample into a test well. Upon filling the test well, the sample fluid flows to a feature that allows passage of air moving ahead of the fluid sample as it moves through the fluid flow path, but that seals in the presence of the fluid sample, thereby preventing flow of the fluid sample out of the detection device. The sealing feature can include a self-sealing Porex frit.

Control Portion of a Collected Sample Isolated from a Test Portion of the Collected Sample

Detection devices of the present disclosure can incorporate a control feature to ensure the assay test result is valid and reliable. Embodiments of the detection devices allow a single collected fluid sample to be added to the detection device at one collection well, and for that single collected sample to be split into a control portion and a test portion as the fluid sample travels through the fluid flow path internal to the device (without further user intervention or action). Specifically, the fluid flow path includes features that isolate a first portion of the fluid sample in a control well from a second portion of the fluid sample in a test well. The first or “control” portion and the second or “test” portion of the fluid sample are both derived from the same fluid sample that was added to the detection device at the collection well. When the fluid sample is added to the collection well, it first fills a control well that is isolated from, and not exposed to, the reducing agent present in the detection device. Upon filling of the control well, the fluid sample then flows through a one-way valve and into a reaction well that includes the reducing agent. A one-way valve in the fluid path allows the fluid sample to pass in one direction (from the control well toward the reaction well) but seals against fluid or gas pressure in the opposite direction (from the reaction well toward the control well). The one-way valve can include a flapper valve that is normally in a closed configuration, and is moved to an open configuration by fluid pressure of the fluid sample moving through the valve. The one-way valve can only deflect in one direction in the open configuration, and will seal against an inlet of the valve in the presence of back pressure. Preventing backflow in this manner prevents contamination of the “control” portion of the fluid sample in the control well with the reducing agent, and fluidically isolates the “control” portion of the fluid sample from the “test” portion of the fluid sample.

The fluid flow path of the detection device can be formed using a two-substrate design. The one-way valve can be implemented at an interface between two substrates that can each be independently optimized during manufacture of the detection device. Thus, the two-substrate design allows flexibility in material choices, surface treatments, colors, and assembly methods. For example, depending on the assay chemistry, the collection well may be included in a first substrate that implements a different surface treatment or material composition than the test well included in a second substrate. The two-substrate design of the present disclosure allows the first substrate and the second substrate to be processed differently before assembly, allowing flexibility to meet material requirements of the detection device.

Integrated Heating Features to Heat a Fluid Sample within a Fluid Flow Path

Embodiments of the detection device can include integrated heating features to heat the fluid sample within the fluid flow path of the detection device. These integrated heating features advantageously optimize the start time, amount, and location of heat that is applied internal to the detection device. Supplying heat integrally using embodiments described herein can advantageously shorten the assay reaction time and/or provide an ideal reaction temperature, without the need for additional, external equipment to supply heat, such as an environmental chamber or oven.

The integrated heating can be provided by an exothermic chemical reaction that is activated when an activating agent is exposed to air, water, or other suitable element. The heating components of the integrated chemical heating feature are fully integrated within and remain sealed inside an enclosure of the detection device, such that the integrated chemical heating feature is disposed in waste when the detection device is disposed at the termination of a test event. Advantageously, the integrated chemical heating feature of the present disclosure does not require a power supply, such as a battery.

In one non-limiting embodiment of the present disclosure, water is added to a reservoir at the start of a test procedure. The water is wicked into a cavity using a wicking layer (such as a wicking paper), where the water interacts with an exothermic material present in the cavity. The wicking paper can control the flow of water into the cavity, thereby controlling the reaction rate of the water with the exothermic material. The exothermic material can include magnesium (Mg), which oxidizes in the presence of water and becomes a thermodynamic source of heat. Sodium chloride (NaCl) and iron (Fe) can be included in the cavity to kinetically enhance the rate of reaction. A phase change material can be included in the integrated chemical heating feature to act as a buffer in the reaction, to prevent the reaction temperature from exceeding a predetermined limit. The integrated chemical heating feature can be configured to generate heat at a precise time following activation, and to continue generating heat at a particular temperature for a duration specific to a selected assay. The integrated chemical heating feature can include chemicals that are non-toxic, safe, and disposable in a standard waste stream.

Embodiments of non-chemical integrated heating features can also be implemented in detection devices of the present disclosure, as described in detail below. In one non-limiting example, a resistive heating element connected to a power source is housed within the same enclosure as the detection device. The integral resistive heating element generates heat that is conducted to the portion of the detection device housing the fluid sample. The integral resistive heating element can also be disposable in a waste stream that accepts battery chemistry.

Various embodiments will be described below in conjunction with the drawings for purposes of illustration. It should be appreciated that many other implementations of the disclosed concepts are possible, and various advantages can be achieved with the disclosed implementations. It will be appreciated that some but not all of the above-described features of sample collection volume control, internal pressure generation and artifact reduction, isolation of a control portion from a test portion of a collected sample, and integrated heating features can be implemented in a detection device in accordance with the present disclosure.

### Overview of Example Detection Devices According to the Present Disclosure

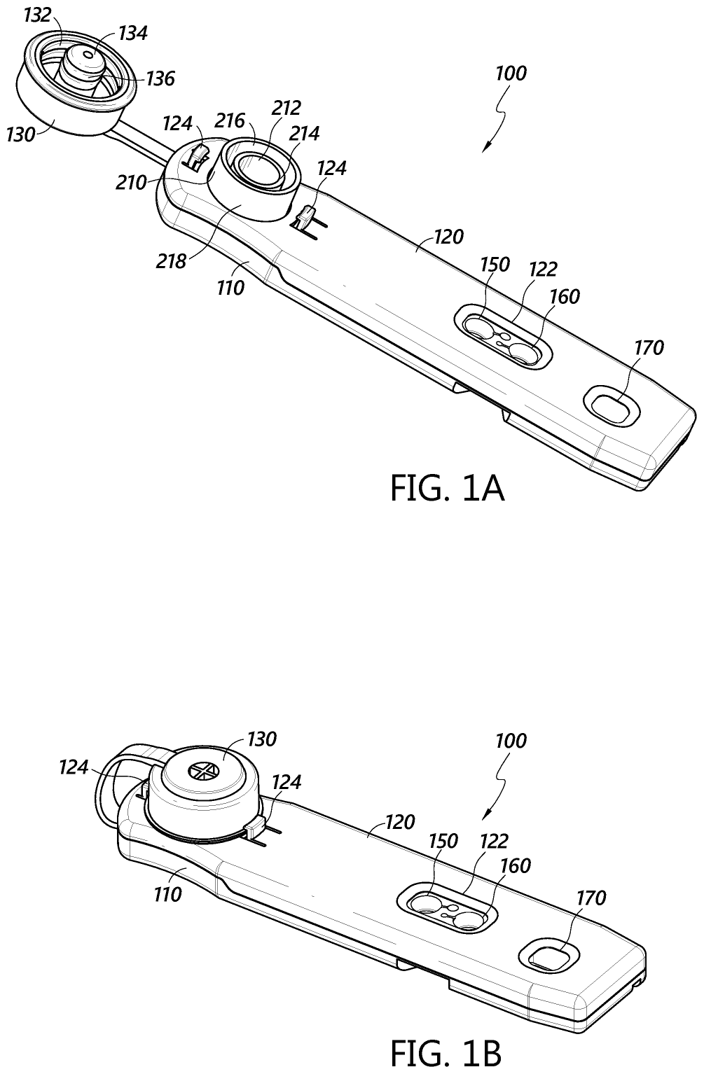

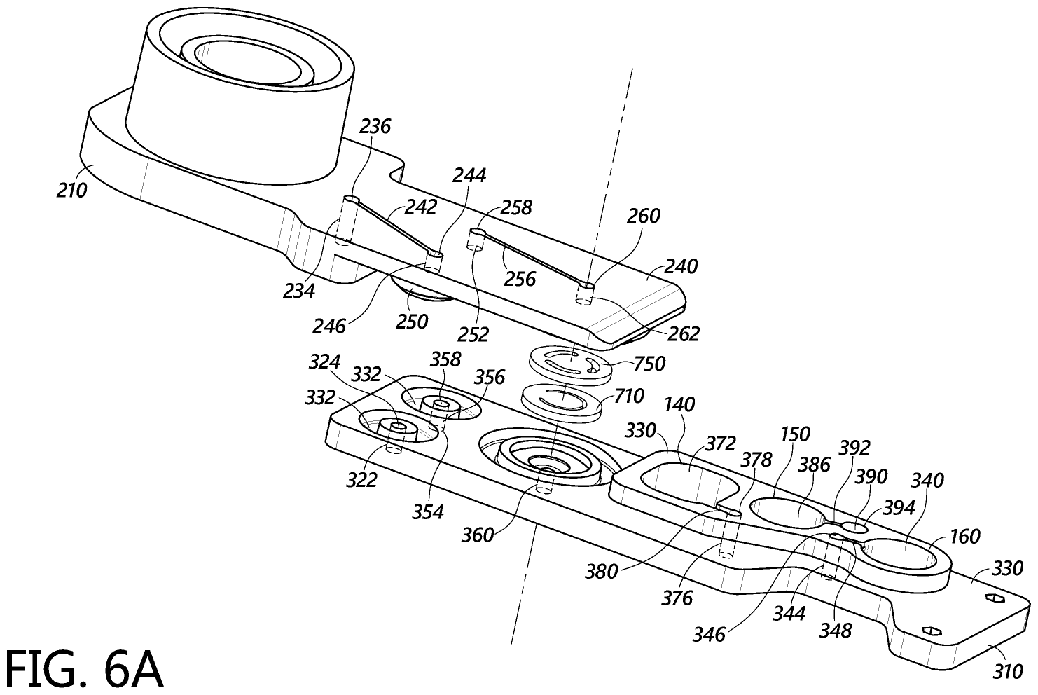

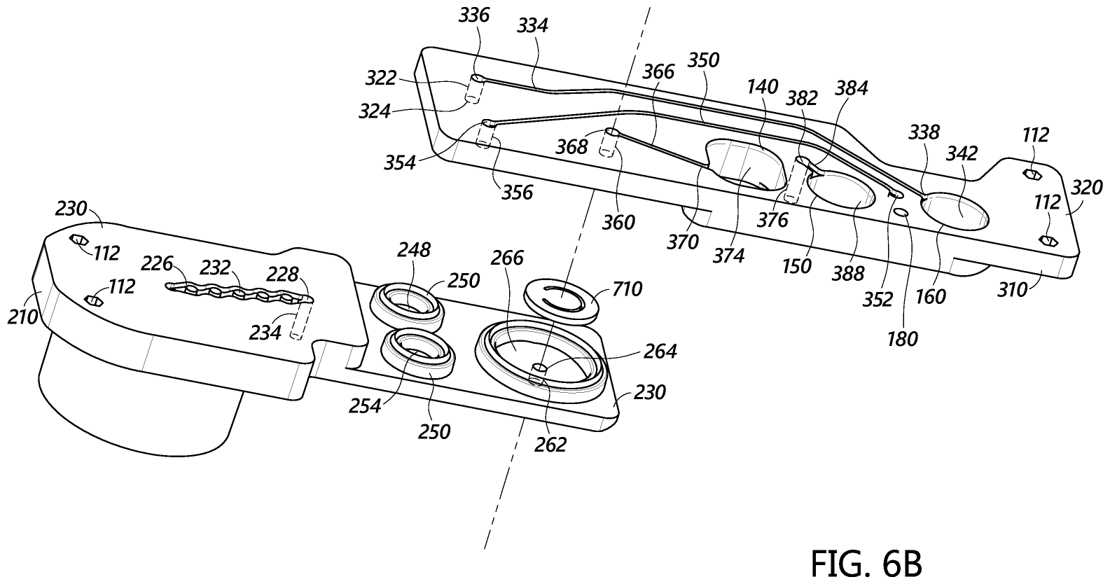

FIG. 1A illustrates an example detection device 100 according to the present disclosure. The detection device 100 includes a bottom housing 110 and a top housing 120 that engage with one another, and that house the detection device components. The top housing 120 may include a viewing window 122 for viewing and/or measuring a signal at a control well 160 and at a test well 150. The top housing 120 may include a heat activation reservoir 170. The heat activation reservoir 170 can receive a heat activating agent, such as buffer, water, or any other heat activating agent capable of activating a heating element located within the detection device housing. The detection device 100 can include a gas vent 180 (illustrated in FIG. 6B). The gas vent 180 may allow air or gases to evacuate the fluid flow path of the detection device 100.

The detection device 100 further includes a cap 130. The cap 130 includes an outer seal 132, a plunger 134, and an inner seal 136. The cap 130 couples with a sample reservoir 212 of a top substrate 210 described in detail below. The sample reservoir 212 includes a reservoir wall 214. The sample reservoir 212 may also include an overflow reservoir 216, which includes an overflow reservoir wall 218. The detection device 100 may also include one or more locking features 124 for engaging the cap 130.

FIG. 1B illustrates an example detection device 100 with the cap 130 closed, such that a lip on the cap 130 engages with a locking feature 124. In the closed position shown in FIG. 1B, the plunger 134 of the cap 130 couples with the sample reservoir 212. The coupling of the plunger 134 with the sample reservoir 144 pushes excess fluid sample that is in the sample reservoir 212 into the overflow reservoir 216. In addition, engaging the plunger 134 in the sample reservoir 212 generates pressure that propels liquid sample through the fluid path of the detection device. The inner seal 136 of the plunger 134 engages with the reservoir wall 214, which both pushes excess liquid sample to the overflow reservoir 216 and which generates pressure to propel the sample through the fluid path by creating a seal. The outer seal 132 of the cap 130 engages with the overflow reservoir wall 218, thereby preventing leakage of fluid sample from the detection device 100.

The interaction between the interior walls of the sample reservoir 212 and the outer surface of the plunger 134 is a mechanism that measures a precise, pre-determined volume of fluid sample and also inputs that specific volume of fluid sample into the detection device 100. As a result, a user is not required to measure beforehand a precise volume of fluid sample to add to the sample reservoir 212. Instead, the user can apply an approximate volume of fluid sample to the sample reservoir 212. The action of closing the cap 130 engages the plunger 134 with the sample reservoir 212. Applying continued pressure on the cap 130 to move the plunger 134 further into the sample reservoir 212 displaces any portion of the fluid sample that exceeds the pre-determined volume from the sample reservoir 212 and into the overflow sample reservoir 216, and simultaneously propels the precise necessary volume of fluid sample through the fluid flow path of the detection device 100. Advantageously, excess liquid sample that has moved to overflow sample reservoir 216 remains completely sealed within the detection device 100. Embodiments of the detection device according to the present disclosure therefore avoid contamination of the surrounding environment and minimize handling of excess fluid sample (that can potentially include a hazardous contaminant) by the user.

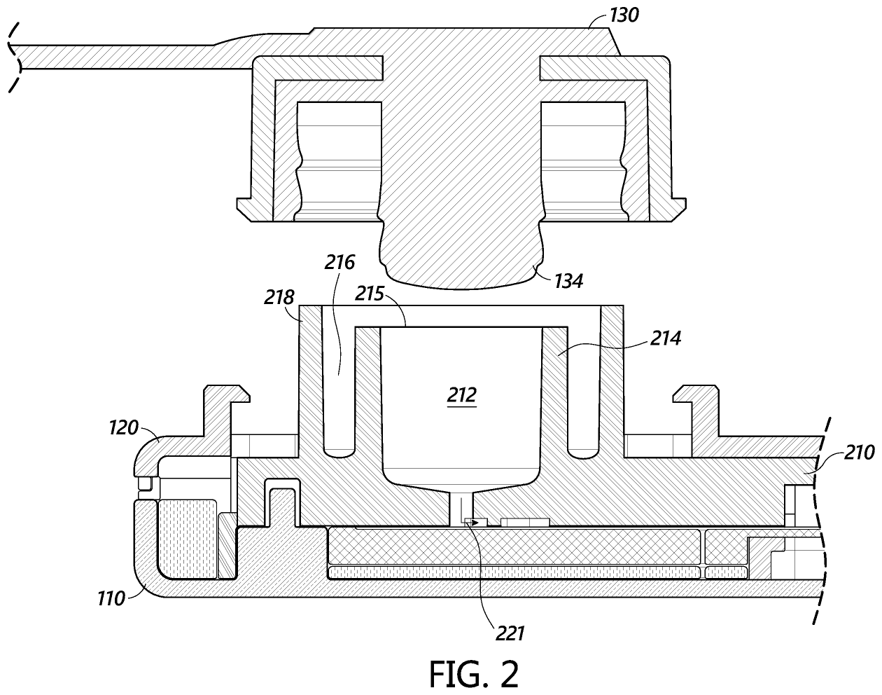

FIG. 2 illustrates a cross-sectional view of sample volume collection control features of the example detection device 100 of FIGS. 1A and 1B. The cross-sectional view shows the bottom housing 110, the top housing 120, and a top substrate 210. The top substrate 210 will be described in greater detail with reference to further figures. Upon placement of a fluid sample in the sample reservoir 212, excess fluid sample flows from the sample reservoir 212 to the overflow reservoir 216. The outer surface of the plunger 134 (not illustrated in FIG. 2 but described above with reference to FIGS. 1A and 1B) engages with the reservoir walls 214 of the sample reservoir 212, and displaces excess fluid sample up over the reservoir walls 214 (as shown at the arrows) and into the overflow reservoir 216, and simultaneously propels a precise, predetermined volume of fluid sample into the fluid flow path along a direction 221 of fluid flow. An inner seal 136 of the plunger 134 (illustrated in FIG. 1A) engages with the reservoir wall 214, which controls the removal of excess fluid sample from the sample reservoir 212, and which also generates pressure for propelling the precise, predetermined volume of fluid sample in the direction 221 of fluid flow into the fluid flow path. As noted above, the cap 130 of this example also includes an outer seal 132, which engages with an exterior surface of an overflow reservoir wall 218 to prevent leakage of fluid sample from the detection device 100.

In some embodiments of the detection device 100, the sample reservoir 212 has a volume of about 240 μL. In one non-limiting example, the pre-determined volume of sample to be propelled from the sample reservoir 212 and into the fluid flow path of the detection device 100 is about 240 μL. In this example, the reaction well (such as a reaction well 140 described in further detail below) receives about 100 μL of sample. Advantageously, a user can dispense a fluid sample having a volume that approximates 240 μL by filling the sample reservoir 212 until the sample reaches a top surface 215 of the sample reservoir 212. When the cap 130 is engaged with the sample reservoir 212, a portion of the sample volume in the sample reservoir 212 may overflow into the overflow sample reservoir 216. The plunger 134 of the cap 130 can be shaped and sized to ensure that when a portion of the sample in the sample reservoir 212 moves into the overflow sample reservoir 216 during engagement of the cap 130, a pre-determined volume of the sample (about 100 μL) is delivered through the fluid flow path to the reaction well 140. Embodiments of the detection device 100 allow a user to deliver a pre-determined volume of sample to the detection device 100 by adding the sample to the sample reservoir 212 until the sample reaches the top surface 215 of the sample reservoir 212, and then engaging the cap 130 with the sample reservoir 212. The pre-determined volume may correspond to a total volume of fluid within the fluid flow path.

The above-described sample collection volume control features advantageously allow an operator to perform two simple steps (fill the sample 212 reservoir with a fluid sample and close the cap 130) to begin a test event, eliminating the need to measure a precise volume of fluid sample before adding the fluid sample to the detection device. Embodiments of the sample collection volume control features significantly reduce the user's exposure to and handling of the collected fluid sample before the user adds the collected fluid sample to the detection device. The sample collection volume control features also minimize the user's exposure to and handling of excess fluid sample that is moved to the overflow sample reservoir 216. For example, the user can simply close the cap 130 of the detection device to begin a test event, and need not remove or pipette out excess fluid sample before initiating the test event. In addition, embodiments of the sample collection volume control features seal the fluid sample, which can include a hazardous contaminant, within the detection device 100, thereby minimizing the risk of contamination of the surrounding environment.

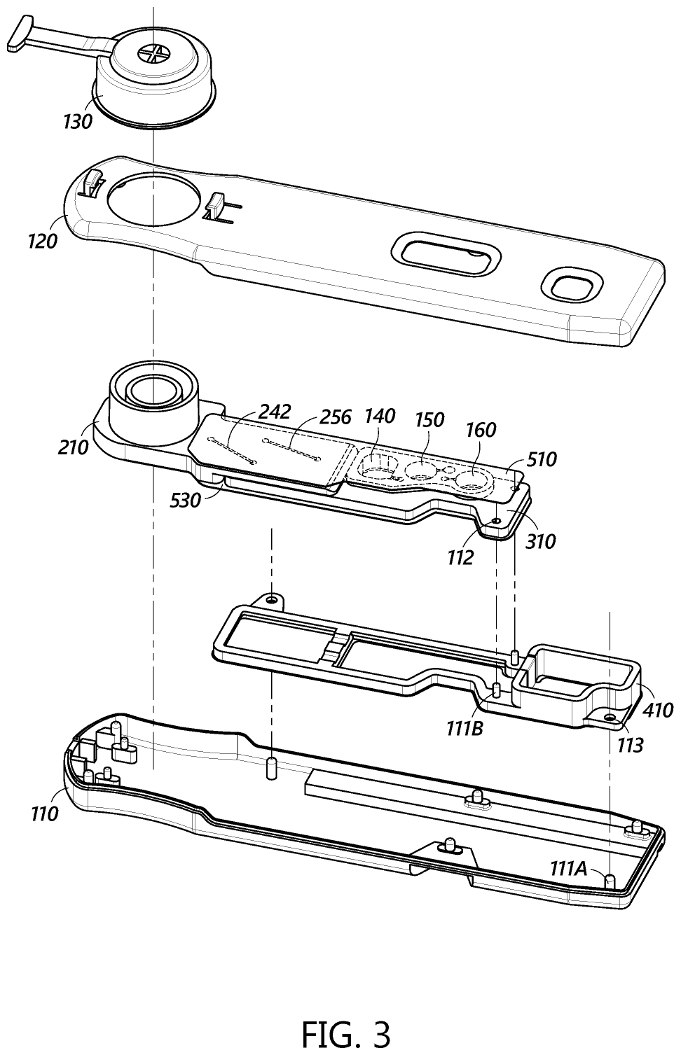

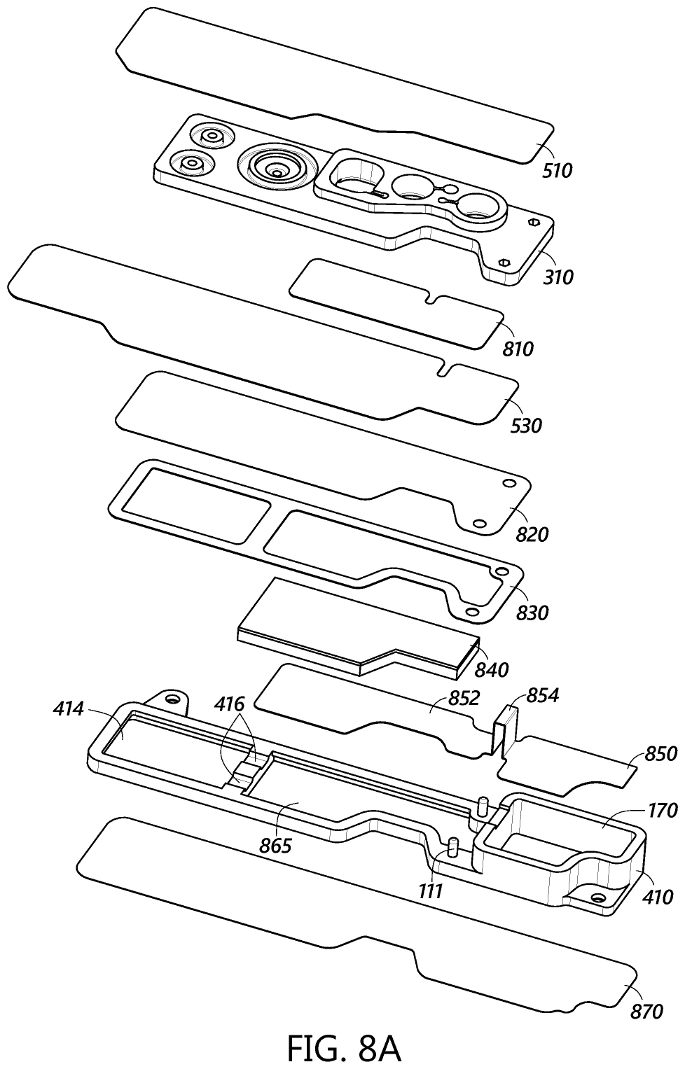

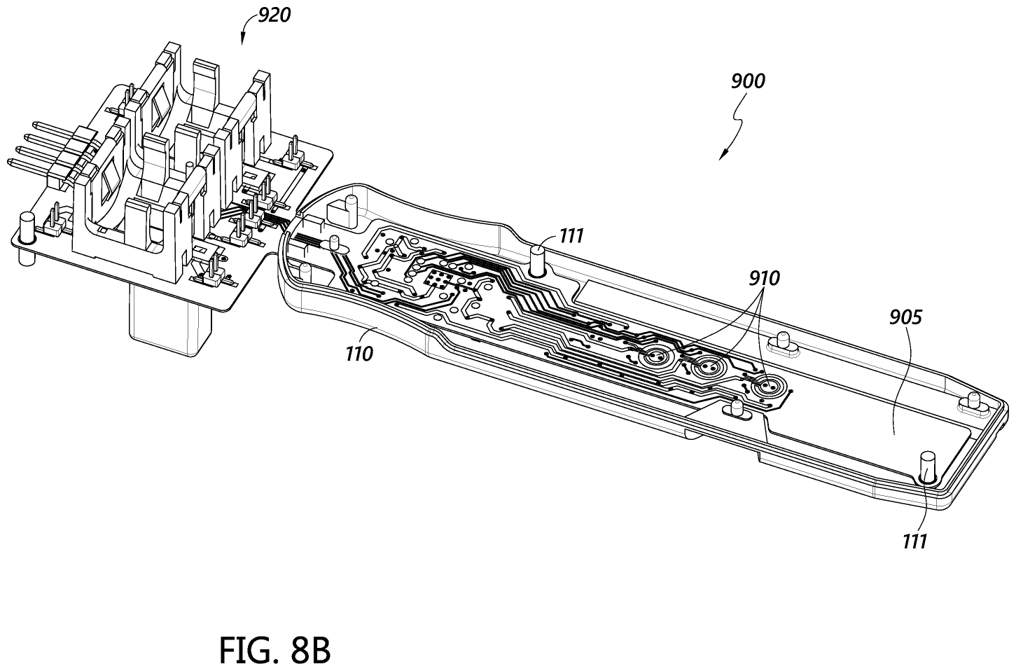

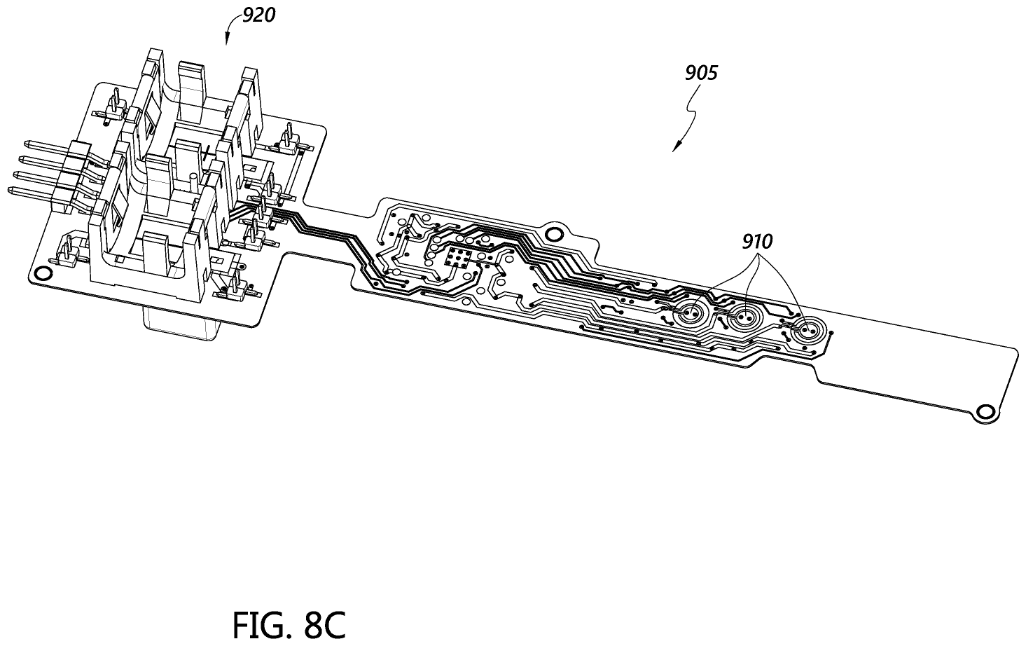

FIG. 3 illustrates the example detection device 100 of FIG. 1A in exploded view. The detection device 100 includes the bottom housing 110, the top housing 120, and the cap 130, as described with reference to FIGS. 1A and 1B. Enclosed within the bottom housing 110 and the top housing 120 is a fluid flow path, which may traverse one or more substrates, such as a top substrate 210 as described in FIG. 2, and a bottom substrate 310. As will be described in detail below, the top substrate 210 and the bottom substrate 310 can define portions of the fluid flow path. The detection device 100 may also include a top layer 510, which seals two portions of the fluid flow path that are defined in the top substrate 210 (see surface channels 242, 256 illustrated and discussed below with reference to FIG. 6A). A top layer 510 also seals portions of the test well 150, the control well 160, and a reagent well 140 that are defined in the bottom substrate 310. In addition to sealing portions of the channels 242, 256 and the wells 150, 160, 140 to confine the fluid sample to the detection device 100 when the fluid is present in these structures, the top layer 510 also seals the fluid flow path from exposure to the outside environment. Advantageously, embodiments of the top layer 510 can be transparent to allow the user or a detector to view contents of the control well 160 and the test well 150 through the viewing window 122 in the top housing 120. The transparent quality of the top layer 510 is illustrated in FIG. 3, where features below the transparent top layer 510 are depicted in dashed lines. The detection device 100 may also include a heating element reservoir 170 configured to receive a heat activation agent, described in detail below with reference to FIG. 8A.

The bottom housing 110 and top housing 120 may include mating features that align and couple the top housing 120 with the bottom housing 110. The mating features can include snap-fit or press-fit features such as posts 111 and receptacles 112. The bottom housing 110 and the top housing 120 can also include mating features that align and couple the top substrate 210, the bottom substrate 310, and the heating element substrate 410 to the bottom housing 110 and the top housing 120. The mating features can facilitate alignment of the top housing 120 with the bottom housing 110 before press-fitting the housings together using press-fit connections. For example, post 111A in the bottom housing 110 can align with and engage tab 113 in the heating element substrate 410 and a receptacle (not shown) in the underside of the top housing 120, and post 111B of the heating element substrate 410 can align with and engage receptacle 112 of the bottom substrate 310. The mating features can ensure that the housings are aligned appropriately before they are coupled together, that the inner components of the detection device 100 engage in the appropriate orientation with the housings, and prevent movement or displacement of the inner components during operation. Additional or different features may also be present to facilitate coupling of the bottom housing 110 and the top housing 120 in alignment with the internal components, including but not limited to lips, ledges, tabs, guides, or other suitable features.

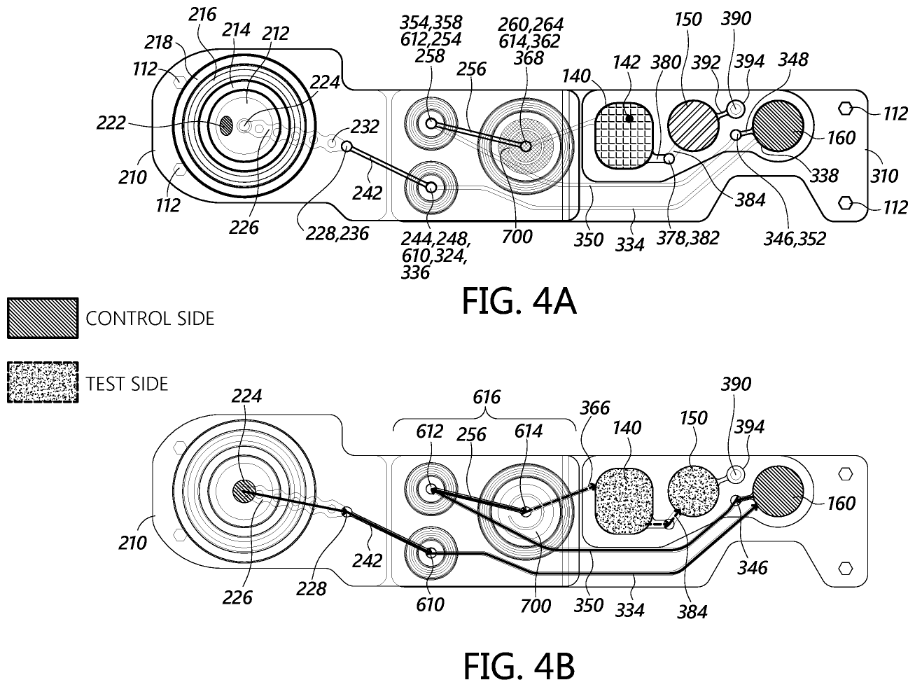

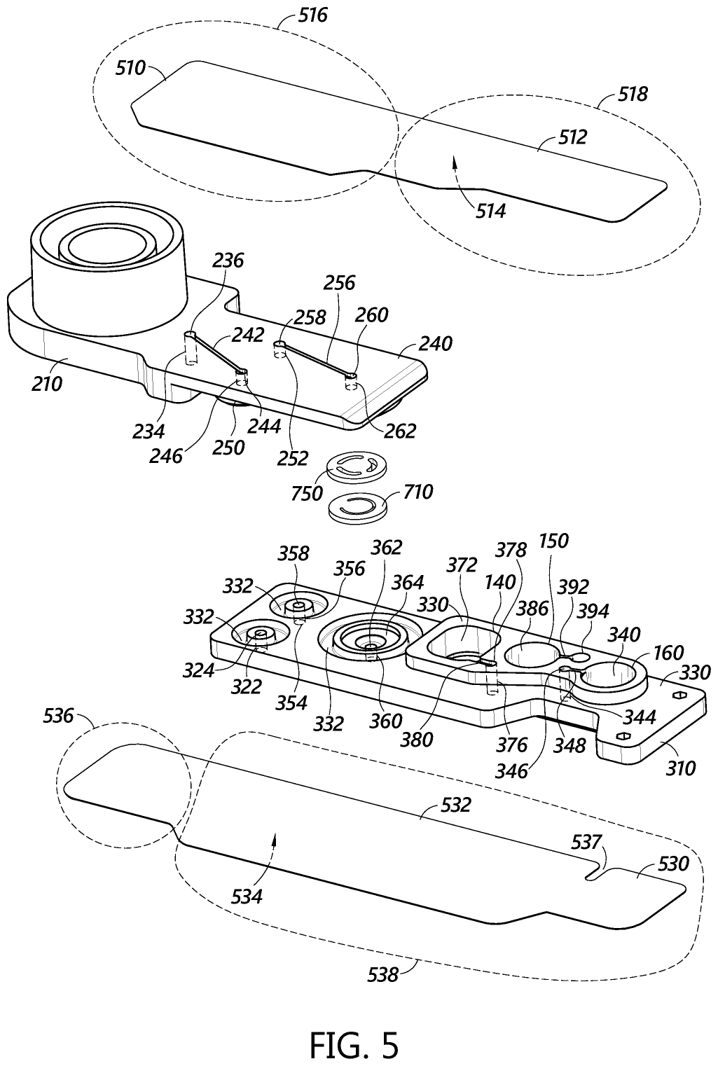

An example fluid flow path through the detection device 100 will now be described with reference to FIGS. 4A, 4B, 5, 6A, and 6B. FIG. 4A illustrates the example fluid flow path prior to application of a sample through the flow path, and FIG. 4B illustrates the fluid flow path of FIG. 4A after flow of the sample through the flow path. FIG. 5 illustrates an exploded view of the top layer 510, the top substrate 210, a component of a one-way valve, the bottom substrate 310, and a bottom layer 530 of the example detection device 100. FIG. 6A illustrates a top perspective view of the top substrate 210 and the bottom substrate of the detection device 100. FIG. 6B illustrates a bottom perspective view of the top substrate 210 and the bottom substrate 310 of the detection device 100. It will be understood that the layout, dimensions, and arrangement of the fluid flow path are examples, and other configurations can be implemented in accordance with the present disclosure.

The example fluid flow path traverses a top substrate 210 and a bottom substrate 310, which couple together to transition the flow path from one substrate to another at junction points that will be described in detail below. The junction points 610, 612, and 614 are located in a region 616 where the top substrate 210 and the bottom substrate 310 overlap when the substrates are coupled. The fluid flow path begins in the sample reservoir 212 at a starting point 224. As described above, the sample reservoir 212 includes the reservoir wall 214, the overflow reservoir 216, and the overflow reservoir wall 218. A mobilizable detection dye 222 is present in the sample reservoir 212. The dye 222 can be dried in place in the sample reservoir 212 during or after manufacture of the detection device. The dye 222 is configured to solubilize into the fluid sample when the sample is placed into the sample reservoir 212. The fluid sample having mobilizable detection dye 222 solubilized therein, flows or is propelled by the plunger 134 from the sample reservoir 212 into the fluid flow path at the starting point 224.

The fluid flow path includes a mixing channel 226 that begins at the starting point 224 and extends to a point 228. In embodiments of the present disclosure, fluid does not travel in direction 221 (illustrated in FIG. 2) along the mixing channel 226 before the cap 130 is engaged. In one example, the mixing channel 226 is dimensioned to prevent flow of the sample from the sample reservoir 212 into the mixing channel 226 before the cap 130 is engaged.

As illustrated in FIG. 6B, the mixing channel 226 is defined by a bottom surface 230 of the top substrate 210 and a bottom layer 530. One portion of the bottom layer 530 is coupled to the bottom surface 230 and another portion of bottom layer 530 is coupled to a bottom surface 320 of the bottom substrate 310. In one example, the bottom layer 530 is a laminate material or a film including a first side 532 and an opposing second side 534. After the top substrate 210 and the bottom substrate 310 are coupled together as described above with reference to FIG. 1A, the first side 532 of the bottom layer 530 can be coupled or applied to the bottom surface 230 of the top substrate 210 and the bottom surface 320 of the bottom substrate 310 to seal portions of channels formed in the bottom surfaces of top substrate 210 and the bottom substrate 310. In one example, an adhesive is applied to at least a portion 536 of the first side 532 of the bottom layer 530 to seal components of the top substrate 210, and an adhesive is applied to at least a portion 538 of the first side 532 to seal components of the bottom substrate 310. It will be understood that the bottom layer 530 can be coupled or applied to a surface of a substrate in any suitable manner, including but not limited to applying an adhesive to a side of the bottom layer 530, positioning an adhesive between the bottom layer 530 and the surface of a substrate, and applying an adhesive an adhesive to the surface of the substrate.

The compressive force applied by the plunger 134 on the fluid sample propels the fluid sample from the starting point 224 into the mixing channel 226. A plurality of posts 232 are located in the mixing channel 226 in a configuration that forces fluid to flow around the posts 232 as fluid is propelled through the mixing channel 226, thereby promoting mixing of the 222 440 with the fluid sample. For example, the diverging and converging path of the fluid around the posts 232 can promote mixing of the dye within the fluid. In some examples, the dye 222 and the fluid sample form a homogeneous mixture when the fluid sample reaches the point 228. As will be explained in greater detail below, the reconstituted dye 222 mixed with the fluid sample is used in a colorimetric detection of an analyte of interest in the fluid sample, if present.

The fluid sample having dye 222 mixed therein continues to flow through the mixing channel 226 defined in the top substrate 210 to the point 228 at the bottom surface 230 of the top substrate 210, illustrated in FIG. 6B. The fluid flow path continues through a transverse channel 234, which passes through the top substrate 210 between the point 228 to a point 236 at a top surface 240 of the top substrate 210, illustrated in FIGS. 5 and 6A. The transverse channel 234 that passes through the top substrate 210 between the point 228 and the point 236 is illustrated in dashed lines in FIGS. 5, 6A, and 6B.

The transverse channel 234 connects to a surface channel 242 located along the top surface 240 of the top substrate 210. Thus, the fluid flow path next continues within the top substrate 210 through the surface channel 242. The surface channel 242 is defined between the top surface 240 of the top substrate 210 and the top layer 510. In one example, the top layer 510 is a laminate material or a film including a first side 512 and an opposing second side 514. The second side 514 of the top layer 510 can be coupled or applied to the top surface 240 of the top substrate 210 to seal the surface channel 242 formed within the top surface 240 of the top substrate 210. In one example, an adhesive is applied to at least a portion 516 of the second side 514 of the top layer 510. It will be understood that the top layer 510 can be coupled or applied to a surface of a substrate in any suitable manner, including but not limited to applying an adhesive to a side of the top layer 510, positioning an adhesive between the top layer 510 and the surface of a substrate, and applying an adhesive an adhesive to the surface of the substrate.

The surface channel 242 extends between the point 236 and a point 244. Point 244 of the top substrate 210 connects to a transverse channel 246. The transverse channel 246 passes through the top substrate 210 between the point 244 to a point 248 at the bottom surface 230 of the top substrate 210, illustrated in FIG. 6B. Thus, the fluid flow path next continues within the top substrate 210 through the transverse channel 246 between the point 244 and the point 248. The transverse channel 246 that passes through the top substrate 210 between the point 244 and the point 248 is illustrated in dashed lines in FIGS. 5 and 6A.

At point 248, the fluid flow transitions from the top substrate 210 to the bottom substrate 310 at a first junction point 610. The first junction point 610 is the location where the transverse channel 246 in the top substrate 210 fluidically connects with a transverse channel 322 in the bottom substrate 310. The first junction point 610 can be formed when the top substrate 210 and the bottom substrate 310 are aligned and coupled together in such a way that the point 248 of the transverse channel 246 in the top substrate 210 is fluidically coupled to a point 324 of the transverse channel 322 in the bottom substrate 310. Thus, the first junction point 610 transitions the fluid flow path from the top substrate 210 to the bottom substrate 310.

In the non-limiting example illustrated in FIGS. 6A and 6B, the bottom surface 230 of the top substrate 210 includes a first sealing rim 250 formed around the point 248, and a top surface 330 of the bottom substrate 310 includes a sealing recess 332 formed around the point 324. Coupling the top substrate 210 and the bottom substrate 310 as described above with reference to FIG. 1A can cause the first sealing rim 250 to sealingly couple to the sealing recess 332, to prevent or contain any fluid leaking at the first junction point 610. It will be understood that these sealing features are optional, and other sealing configurations can be implemented.

The transverse channel 322 connects to a surface channel 334 at a point 336 located on the bottom surface 320 of the bottom substrate 310. The transverse channel 322 that passes through the bottom substrate 310 between the point 324 and the point 336 is illustrated in dashed lines in FIGS. 5, 6A, and 6B. The fluid flow path next continues within the bottom substrate 310 through the surface channel 334. The surface channel 334 is defined between the bottom surface 320 of the bottom substrate 310 and the bottom layer 530. As explained above, in one example, the bottom layer 530 is a laminate material or a film including a first side 532 and an opposing second side 534. In one non-limiting example, an adhesive is applied to at least a portion 538 of the first side 532. The first side 532 of the bottom layer 530 can be coupled or applied to the bottom surface 320 of the bottom substrate 310 to seal the surface channel 334 formed within the bottom surface 320 of the bottom substrate 310.

The surface channel 334 extends between the point 336 and the control well 160. Thus, the fluid flow path continues along the surface channel 334 until the surface channel 334 meets the control well 160 at point 338 in the bottom surface 320 of the bottom substrate 310. The control well 160 is defined within the bottom substrate 310 and between two layers that are coupled to the top and bottom surfaces of the bottom substrate 310. In this example, the control well 160 is generally defined by a cylindrically-shaped passage within the bottom substrate 310, with a top surface 340 of the control well 160 defined by a portion 518 of the top layer 510 and a bottom surface 342 of the control well 160 defined by the portion 538 of the bottom layer 530. It will be understood that other configurations for forming the control well 160 are possible.

The fluid sample begins to fill the control well 160, entering the control well 160 at the point 338. As illustrated in FIG. 6B, the point 338 is fluidically connected to the control well 160 at the bottom of the control well 160. Thus, in implementations of the present disclosure, the control well 160 is filled with fluid sample from the bottom to the top of the control well 160. The top layer 510 can be transparent, such that the presence of the fluid sample in the control well 160 can be visible through the top layer 510 that forms the top surface 340 of the control well 160. Further, the sealed top surface 340 of the control well 160 aligns with the viewing window 122 in the top housing 120. Advantageously, this arrangement allows the dye in the fluid sample in the control well 160 to be measured and detected through the viewing window 122. In some embodiments, the dye is a colorimetric dye, and measurement is a colorimetric measurement.

Accordingly, embodiments of the detection device 100 allow a user to visually confirm that the fluid sample (which has been mixed with dye 222 as described above) flowed from the sample reservoir 212 to the control well 160, by visually checking to see if the dyed fluid sample is visible in the control well through the viewing window 122. This visual assessment of the control well 160 at this point in the test event allows the user to confirm that the detection device 100 is operating as intended. Further, embodiments of the detection device 100 advantageously fill the control well 160 from the bottom of the well to the top of the well, such that air present in the control well 160 is displaced out the top of the control well 160 as the well fills with the fluid sample. As a result, undesirable introduction of air bubbles into the fluid sample as it passes through the control well 160 is minimized, thereby enhancing colorimetric measurements of the portion of the fluid sample that flows to the test well 150.

The fluid flow path next moves from the control well 160 to a transverse channel 344 at a point 346 located in the top surface 330 of the bottom substrate 310. When the fluid sample reaches the top surface 340 of the control well 160, the fluid sample flows through portion 348 of the control well 160 to the point 346, and then back down through the bottom substrate 310 through transverse channel 344. Accordingly, the fluid flow path moves away from the top surface 330 of the bottom substrate 310 and toward the bottom surface 320 of the bottom substrate 310.

The transverse channel 344 connects to a surface channel 350 at a point 352 located on the bottom surface 320 of the bottom substrate 310. The transverse channel 344 that passes through the bottom substrate 310 between the point 346 and the point 352 is illustrated in dashed lines in FIGS. 5 and 6A. The fluid flow path next continues within the bottom substrate 310 through the surface channel 350. The surface channel 350 extends between point 352 and a point 354 on the bottom surface 320 of the bottom substrate 310. The surface channel 350 is defined between the bottom surface 320 of the bottom substrate 310 and the bottom layer 530. As explained above, in one example, the bottom layer 530 is a laminate material or a film including a first side 532 and an opposing second side 534. In one non-limiting example, an adhesive is applied to at least a portion 538 of the first side 532. The first side 532 of the bottom layer 530 can be coupled or applied to the bottom surface 320 of the bottom substrate 310 to seal the surface channel 350 formed within the bottom surface 320 of the bottom substrate 310.

Point 354 of the bottom substrate 310 connects to a transverse channel 356. The transverse channel 356 passes through the bottom substrate 310 between the point 354 to a point 358 at the top surface 330 of the bottom substrate 310, illustrated in FIGS. 5 and 6A. The transverse channel 356 that passes through the bottom substrate 310 between the point 354 and the point 358 is illustrated in dashed lines in FIGS. 5, 6A, and 6B. Thus, the fluid flow path next continues within the bottom substrate 310 through the transverse channel 356 between the point 354 and the point 358.

At point 358, the fluid flow transitions from the bottom substrate 310 back to the top substrate 210 at a second junction point 612. The second junction point 612 is the location where the transverse channel 356 in the bottom substrate 310 fluidically connects with a transverse channel 252 in the top substrate 210. The second junction point 612 can be formed when the top substrate 210 and the bottom substrate 310 are aligned and coupled together in such a way that the point 358 of the transverse channel 356 in the bottom substrate 310 is fluidically coupled to a point 254 of the transverse channel 252 in the top substrate 210. Thus, the second junction point 612 transitions the fluid flow path from the bottom substrate 310 to the top substrate 210.

In the non-limiting example illustrated in FIGS. 6A and 6B, the bottom surface 230 of the top substrate 210 includes a second sealing rim 250 formed around the point 254, and the top surface 330 of the bottom substrate 310 includes a second sealing recess 332 formed around the point 358. Coupling the top substrate 210 and the bottom substrate 310 as described above with reference to FIG. 1A can cause the second sealing rim 250 to sealingly couple to the second sealing recess 332, to prevent or contain any fluid leaking at the second junction point 612. It will be understood that these sealing features are optional, and other sealing configurations can be implemented.

The transverse channel 252 connects to a surface channel 256 at a point 258 located on the top surface 240 of the top substrate 210. The transverse channel 252 that passes through the top substrate 210 between the point 254 and the point 258 is illustrated in dashed lines in FIGS. 5 and 6A. The fluid flow path next continues within the top substrate 210 through the surface channel 256. The surface channel 256 extends between point 258 and a point 260 on the top surface 240 of the top substrate 210. The surface channel 256 is defined between the top surface 240 of the top substrate 210 and the top layer 510. As explained above, in one example, the top layer 510 is a laminate material or a film including a first side 512 and an opposing second side 514. In one non-limiting example, an adhesive is applied to at least a portion 516 of the second side 514. The second side 514 of the top layer 510 can be coupled or applied to the top surface 240 of the top substrate 210 to seal the surface channel 256 formed within the top surface 240 of the top substrate 210.

Point 260 of the top substrate 210 connects to a transverse channel 262. The transverse channel 262 passes through the top substrate 210 between the point 260 to a point 264 at the bottom surface 230 of the top substrate 210, illustrated in FIG. 6B. Thus, the fluid flow path next continues within the top substrate 210 through the transverse channel 262 between the point 260 and the point 264. The transverse 262 that passes through the top substrate 210 between the point 260 and the point 264 is illustrated in dashed lines in FIGS. 5, 6A, and 6B.

At point 264, the fluid flow transitions from the top substrate 210 back to the bottom substrate 310 at a third junction point 614. The third junction point 614 is the location where the transverse channel 262 in the top substrate 210 fluidically connects with a transverse channel 360 in the bottom substrate 310. The third junction point 614 can be formed when the top substrate 210 and the bottom substrate 310 are aligned and coupled together in such a way that the point 264 of the transverse channel 262 in the top substrate 210 is fluidically coupled to a point 362 of the transverse channel 360 in the bottom substrate 310. Thus, the third junction point 614 transitions the fluid flow path from the top substrate 210 to the bottom substrate 310.

In one example, the bottom surface 230 of the top substrate 210 includes a third sealing rim 250 formed around the point 264, and the top surface 330 of the bottom substrate 310 includes a third sealing recess 332 formed around the point 362. Coupling the top substrate 210 and the bottom substrate 310 as described above with reference to FIG. 1A can cause the third sealing rim 250 to sealingly couple to the third sealing recess 332, to prevent or contain any fluid leaking at the third junction point 614. It will be understood that these sealing features are optional, and other sealing configurations can be implemented.

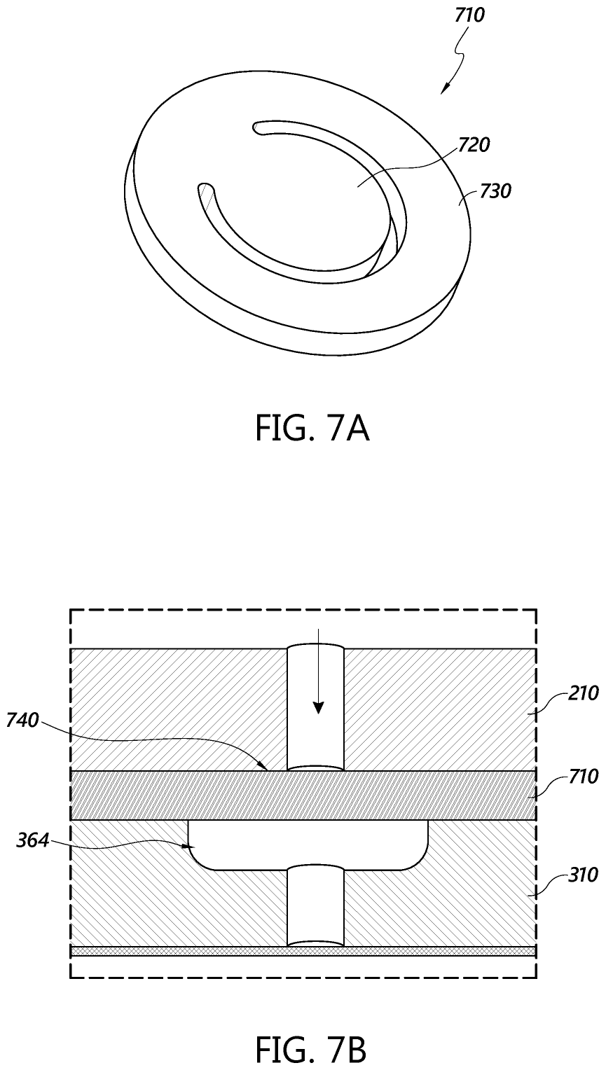

Embodiments of the detection device 100 can include a one-way valve 700 at the third junction point 614. In one non-limiting, the one-way valve is a flapper valve that includes a surface 266 within the third sealing rim 250 of the top substrate 210, a flapper relief cavity 364 of the bottom substrate 310, and an elastomeric element 710. An optional support structure 750 may further be included in the flapper valve assembly. At the third junction point 614, the fluid flow path passes from the top substrate 210, through the flapper valve 700, to the bottom substrate 310. As will be described in greater detail below with reference to FIGS. 7A and 7B, the one-way flapper valve 700 only permits materials at the third junction point 614 (such as the fluid sample or a gas generated in the detection device 100) to flow in this single direction (from the top substrate 210 to the transverse channel 360 of the bottom substrate 310), and does not permit backflow of material in the opposite direction (from the bottom substrate 310 to the transverse channel 262 of the top substrate 210). Accordingly, the one-way flapper valve 700 allows the flow of gas or liquid in a single direction through the third junction point 614 (a downstream direction toward the reagent well 140), and does not allow backflow of gas or liquid through the third junction point 614 (in the upstream direction, from the reagent well 140 toward the control well 160).

Embodiments of the detection device 100 that include a one-way valve 700 at the third junction point 614 can advantageously maintain a unidirectional flow of fluid sample through the fluid flow path of the detection device 100. In addition to controlling the flow of fluids and gases at the third junction point 614, the one-way valve 700 can ensure unidirectional flow of fluid at other locations within the fluid flow path. The generation of gases in locations of the detection device 100 downstream of the third junction point 614 can change internal pressures or create vacuum conditions at various locations within the fluid flow path of the detection device 100. These pressures and vacuum conditions can act on portions of the fluid sample in a way that cause portions of the fluid sample to flow back through the fluid flow path (in an upstream direction), rather than in a forward direction through the fluid flow path (in a downstream direction). It has been found that the one-way valve 700 at the third junction point 614, acting in conjunction with the pressure imparted on the fluid sample by the plunger 134, can move a predetermined, precise volume of fluid sample through the flow path in a predictable, consistent manner from the sample reservoir 212 to the test well 150.

After passing through the one-way flapper valve 700 at the third junction 614, the fluid flow path continues to the point 362, where it enters the transverse channel 360 of the bottom substrate 310. The transverse channel 360 connects to a surface channel 366 at a point 368 located on the bottom surface 320 of the bottom substrate 310. The transverse channel 360 that passes through the bottom substrate 310 between the point 362 and the point 368 is illustrated in dashed lines in FIGS. 5 and 6B. The fluid flow path next continues within the bottom substrate 310 through the surface channel 366. The surface channel 366 is defined between the bottom surface 320 of the bottom substrate 310 and the layer 530. As explained above, in one example, the bottom layer 530 is a laminate material or a film including a first side 532 and an opposing second side 534. In one non-limiting example, an adhesive is applied to at least a portion 538 of the first side 532. The first side 532 of the bottom layer 530 can be coupled or applied to the bottom surface 320 of the bottom substrate 310 to seal the surface channel 366 formed within the bottom surface 320 of the bottom substrate 310.

The surface channel 366 extends between the point 368 and the reagent well 140. Thus, the fluid flow path continues along the surface channel 366 until the surface channel 366 meets the reagent well 140 at point 370 in the bottom surface 320 of the bottom substrate 310. The reagent well 140 is defined within the bottom substrate 310 and between two layers that are coupled to the top and bottom surfaces of the bottom substrate 310. In this example, the reagent well 140 is generally defined by a passage within the bottom substrate 310, with a top surface 372 of the reagent well 140 being defined by the portion 518 of the top layer 510 and a bottom surface 374 of the reagent well 140 being defined by the portion 538 of the bottom layer 530. It will be understood that other configurations for forming the reagent well 140 are possible.

The fluid sample begins to fill the reagent well 140, entering the reagent well 140 at the point 370 located. As illustrated in FIG. 6B, the point 370 is fluidically connected to the reagent well 140 at the bottom of the reagent well 140. Thus, in implementations of the present disclosure, the reagent well 140 is filled with fluid sample from the bottom to the top of the reagent well 140. The top layer 510 can be transparent, such that the presence of the fluid sample in the reagent well 140 can be visible through the top layer 510 that seals the top surface 372 of the reagent well 140. Further, the sealed top surface 372 of the reagent well 140 aligns with the viewing window 122 in the top housing 120. Advantageously, this arrangement allows the dye 222 in the fluid sample in the reagent well 140 to be measured and detected through the viewing window 122. In some embodiments, the dye is a colorimetric dye, and measurement is a colorimetric measurement.

Accordingly, embodiments of the detection device 100 allow a user to visually confirm that the fluid sample (which has been mixed with dye 222 as described above) flowed from the sample reservoir 212 to the reagent well 140, by visually checking to see if the dyed fluid sample is visible in the control well through the viewing window 122. This visual assessment of the reagent well 140 at this point in the test event allows the user to confirm that the detection device 100 is operating as intended. Further, embodiments of the detection device 100 advantageously fill the reagent well 140 from the bottom of the well to the top of the well, such that air present in the reagent well 140 is displaced out the top of the reagent well 140 as the well fills with the fluid sample. As a result, undesirable introduction of air bubbles into the fluid sample as it passes through the reagent well 140 is minimized, thereby enhancing colorimetric measurements of the portion of the fluid sample that flows to the test well 150.

The reagent well 140 includes a reducing agent 142. The reducing agent 142 can be added to the reagent well 140 during manufacture of the detection device. The reducing agent 142 is configured to react with the solubilized detection dye 222 in the presence of the analyte of interest in the fluid sample in the reagent well 140. If the fluid sample in the reagent well 140 does not include the analyte of interest, the reducing agent 142 does not react with the solubilized detection dye 222. The reducing agent 142 can be added to the reagent well 140 during manufacture of the detection device. For example, the reducing agent 142 may be dried in the reagent well 140 during manufacture of the detection device 100. In some cases, the reducing agent 142 is added to the reagent well 140 before the top layer 510 is coupled to the top substrate 210 and the bottom substrate 310. If the reducing agent 142 reacts with the dye 222 in the presence of the analyte of interest, the reaction results in generation of a gas and also results in a change of color of the detection dye 222. As described above and in detail below, the generation of the gas within the reagent well 140 advantageously propels the fluid sample into the test well 150 in a way that reduces undesirable artifacts in the fluid sample in the test well, such as bubbles. Further, the change in a physical characteristic of the dye in the presence of the analyte of interest (in this case, a change in the dye from a first color (observed in the control well 160) to a second color (observed in the test well 150)) allows the presence (and in some cases, a quantity) of the analyte of interest in the fluid sample to be detected in the test well 150.

Accordingly, embodiments of the detection device 100 advantageously include an internal mechanism to propel the fluid sample between the reagent well 140 and the test well 150, where the internal mechanism is not actuated unless and until the fluid sample reaches the reagent well 140. In particular, the gas generated by the reaction of the reducing agent 142 with the dye 222 propels the fluid sample through the remaining portion of the fluid flow path, and particularly from the reagent well 140 into the test well 150.

The fluid flow path moves from the reagent well 140 to a transverse channel 376 at a point 378 located in the top surface 330 of the bottom substrate 310. When the fluid sample reaches the top surface 372 of the reagent well 140, the fluid sample flows through portion 380 of the reagent well 140 to the point 378, and then back down through the bottom substrate 310 through the transverse channel 376. Accordingly, the fluid flow path moves away from the top surface 330 of the bottom substrate 310 and toward the bottom surface 320 of the bottom substrate 310.

The transverse channel 376 extends between the point 378 and a point 382 located on the bottom surface 320 of the bottom substrate 310. The transverse channel 376 that passes through the bottom substrate 310 between the point 378 and the point 382 is illustrated in dashed lines in FIGS. 5 and 6B. A portion 384 of the test well 150 extends between the point 382 and an entry to the test well 150. Thus, the fluid flow path continues from point 382, along the portion 384 of the test well 150, and into the test well 150. The test well 150 is defined within the bottom substrate 310 and between two layers that are coupled to the top and bottom surfaces of the bottom substrate 310. In this example, the test well 150 is defined by a cylindrically-shaped passage within the bottom substrate 310, with a top surface 386 of the test well 150 defined by the portion 518 of the top layer 510 and a bottom surface 388 of the test well 150 being defined by the portion 538 of the bottom layer 530. It will be understood that other configurations for forming the test well 150 are possible.

The fluid sample begins to fill the test well 150, entering the test well 150 at the point 382. As illustrated in FIG. 6B, the point 382 is fluidically connected to the test well 150 at the bottom of the test well 150. Thus, in implementations of the present disclosure, the test well 150 is filled with fluid sample from the bottom to the top of the test well 150. The top layer 510 can be transparent, such that the presence of the fluid sample in the test well 150 can be visible through the top layer 510 that seals the top surface 386 of the test well 150. Further, the sealed top surface 386 of the test well 150 aligns with the viewing window 122 in the top housing 120. Advantageously, this arrangement allows the dye in the fluid sample in the test well 150 to be measured and detected through the viewing window 122. In some embodiments, the dye is a colorimetric dye, and measurement is a colorimetric measurement. As described above, the dye 222 of the fluid sample that has entered the test well 150 will change color in the reagent well 140 in the presence of the reducing agent 142 and the analyte of interest in the fluid sample. This change in the color of the dye 222 can be observed through the top layer 510 that seals the top surface 386 of the test well 150, which is visible through the viewing window 122.

Accordingly, embodiments of the detection device 100 allow a user to visually confirm that the fluid sample (which has been mixed with dye 222 as described above) flowed from the sample reservoir 212 to the test well 150, by visually checking to see if the dyed fluid sample is visible in the test well 150 through the viewing window 122. This visual assessment of the test well 150 at this point in the test event allows the user to confirm that the detection device 100 is operating as intended. Further, embodiments of the detection device 100 advantageously fill the test well 150 from the bottom of the well to the top of the well, such that air present in the test well 150 is displaced out the top of the test well 150 as the well fills with the fluid sample. As a result, undesirable introduction of air bubbles into the fluid sample as it fills the test well 150 is minimized, thereby enhancing colorimetric measurements of the portion of the fluid sample present in the test well 150.

The accumulation of fluid sample in the test well 150 allows measurement of a characteristic, such as the color, of the fluid sample at the test well 150. A colorimetric measurement of the fluid sample in the test well 150 can be compared to a colorimetic measurement of the fluid sample in the control well 160. The colorimetric measurement can include measuring an image pixel intensity at the test well 150 and the control well 160. In one non-limiting embodiment, when the analyte of interest is present in the fluid sample, a color shift in the form of a de-colorization (for example, a reduced optical density at the observed wavelength) is measured. In an alternative non-limiting embodiment, a wavelength shift is measured. In this example, when the analyte of interest is present in the fluid sample, the wavelength of a detection signal at the test well 150 is different than a wavelength of a detection signal at the control well 160. The difference in wavelength can be analyzed to determine the presence and/or quantity of analyte of interest in the sample. It will be understood that embodiments of the present disclosure can implement measurement of a color shift (such as, but not limited to, reduced optical density at the observed wavelength), measurement of a wavelength shift, or measurement of a change in any other suitably-observable property.

For a portion of the fluid sample, the fluid flow path can continue from the test well 150 to an overflow well 394 that includes a gas vent 180 and a seal-sealing frit 390, such as a seal-sealing Porex® frit. As shown in FIG. 5, a portion of the bottom layer 530 may include a cut-out 537 in the area below the gas vent 180, such that the bottom layer 530 does not seal the gas vent 180 and gas is permitted to vent into the device housing. The frit 390 can be a self-sealing frit that allows gas within the fluid flow path to pass through the frit and out of the detection device to the external environment, but in the presence of a fluid seals to the passage of gas and the fluid. The overflow well 394 can be fluidically connected to the top surface of the test well 150 through a portion 392. A top surface of the overflow well 394 can be sealed by the portion 518 of the top layer 510 as described above with reference to the top surface 386 of the test well 150. As the fluid sample reaches the top surface of the test well 150, a portion of the fluid sample can flow through the portion 392 and into the overflow well 394. The portion of the fluid sample can interact with the fit 390 positioned in the overflow well.

Advantageously, the frit 390 can serve multiple functions in the detection device 100. The flow of fluid sample through the fluid flow path displaces gas that was present in the fluid flow path. This displaced gas flows through the fluid flow path ahead of the fluid sample to the gas vent 180. The frit 390 can allow the displaced gas to exit the detection device 100. This ensures that the displaced gas does not become pressurized within the fluid flow path and impede the flow of the fluid sample through the fluid flow path of the detection device 100. In addition, the frit 390 prevents passage of a fluid sample out of the detection device 100, thereby ensuring that any portion of the fluid sample that exits the test well 150 is retained within the detection device 100.

Turning again to FIG. 4B, the path and direction of fluid sample through the fluid flow path is illustrated with arrows. Solid arrows represent the flow of fluid sample from the sample reservoir 212, through the control well 160, and to the one-way valve 700. After the fluid sample passes through the one-way valve 700, the flow of fluid sample is represented with in broken line arrows, representative of fluid sample that has passed the one-way valve 700, and is thus on the test side of the detection device 100. The control well 160 is depicted with a different pattern than the pattern of the reagent well 140 and test well 150, representative of the difference in the color of the fluid sample, and thus a difference in the optical signal that would be detected, at the control well 160 compared to the test well 150 when analyte is present in the fluid sample.

FIG. 5 illustrates an exploded view of components of the detection device 100. As explained above, the detection device 100 includes a fluid flow path that may traverse a top substrate 210 and a bottom substrate 310 by passing through transition or junction points, allowing fluid sample to flow back and forth between the top substrate 210 and the bottom substrate 310. It will be understood that this is an example fluid flow path, and other flow paths can be suitably implemented. For example, the fluid flow path may begin in the bottom substrate 310, transition up into the top substrate 210, and then down into the bottom substrate 310. For another example, fewer or more junction points can be implemented.

The fluid flow path has two distinct and separate sides: a control side upstream of the one-way valve 700, and a test side downstream of the one-way valve 700. It will be understood that the term “downstream” refers to the direction of fluid flow when the detection device 100 is operating as intended, and does not necessarily refer to fluid flowing in a downward direction. As explained above, there are portions of the fluid flow path in which fluid flowing from the bottom substrate 310 in an upward direction to the top substrate 210 is flowing downstream. A portion of the one-way valve 700 sits within a flapper relief cavity 364, which allows the flow of fluid sample only in a downstream direction, such that, after passing the valve 700, fluid sample flows downstream to the reagent well 140 and to the test well 150, but does not flow in the opposite direction toward the control well 160. Further, as described above, portions of the fluid flow path are sealed from the outer environment by the top layer 510 in contact with the top substrate 210 and the bottom substrate 310, and by the bottom layer 530 in contact with the bottom substrate 310 and the top substrate 210. Advantageously, the top layer 510 can be transparent such that physical characteristics, such as the color, of the fluid sample can be measured and detected at the control well 160 and at the test well 150.

FIG. 6A illustrates an exploded top view of the top substrate 210 and the bottom substrate 310 of the detection device 100. FIG. 6B illustrates an exploded bottom view of the bottom substrate 310 and the top substrate 210 of the detection device 100. These exploded views depict portions of the fluid flow path, including the mixing feature, features that form junction points 610, 612, and 614, the control well 160, features of the one-way valve, the reagent well 140, and the test well 150.

FIG. 7A illustrates an example elastomeric element 710 of the flapper valve 700 of the detection device 100. The elastomeric element 710 includes a displacement flapper 720 and a support ring 730. FIG. 7B illustrates a cross sectional view of the one-way valve assembly of the detection device 100, including the elastomeric element 710 of FIG. 7A. The fluid sample flows in a single direction through the one-way valve 700 from the top substrate 210 to the bottom substrate 310. The fluid pressure of the fluid sample flowing through the valve 700 displaces the displacement flapper 720 into the flapper relief cavity 364, a recess formed in the bottom substrate 310. Displacement of the flapper 720 into the flapper relief cavity 364 allows the fluid sample to fill the flapper relief cavity 364 and progress through the transverse channel 360 of the bottom substrate 310. Once the fluid sample passes through the valve 700 and into the transverse channel 360, the displacement flapper 720 returns to a non-displaced condition due to its elastomeric properties. The support ring 730 is supported and held in place by the top substrate 210 and the bottom substrate 310 when the displacement flapper 720 is in the non-displaced and displaced conditions. The one-way flapper valve 700 is sealed to the top substrate 210 along a sealing face 740, which helps prevent the flow of fluid sample in a direction opposite the intended fluid flow direction. It will be understood that other suitable valves can be implemented in the detection device 100.

### Example Integrated Heating Features of Detection Devices

Example integral heating elements that can be implemented in detection devices of the present disclosure will now be described. Although an example integral heating element will be described with reference to the detection device 100, aspects of the integral heating elements of the present disclosure can be suitably implemented in any test or detection device in which it is desirable to include an internal or self-contained source of heat. It will also be understood that detection devices of the present disclosure can be suitably implemented without an integral heating element. Further, in embodiments of the detection device that implement an integral heating element, it will be understood that the integral heating element can include any material capable of generating heat. For example, the heating element may be a chemical heating element, a resistive heating element, or any other suitable heating element.

FIG. 8A depicts an exploded view of components of an exemplary integral chemical heating element of the detection device 100. As described above, the detection device 100 includes a top substrate 210 (illustrated in FIG. 5 for example), a bottom substrate 310, a top layer 510, and a bottom layer 530. The detection device 100 also includes the following features positioned below the bottom layer 530: a white background material 810, a sheet 820, a seal 830, a heating element substrate 410, an exothermic heating material 840, a wicking layer (such as a wicking paper) 850, and a layer 870 including a pressure sensitive adhesive (PSA). The white background material 810 is positioned below the bottom layer 530, and can provide a repeatable background for imaging assay results in the test well 150 and the control well 160. Although not illustrated in FIG. 8A, the detection device 100 also includes the bottom housing 110 and the top housing 120 illustrated in FIG. 1A. When coupled together, the bottom housing 110 and the top housing 120 form an enclosure configured to house the above-described components. As described above with reference to FIG. 1A illustrating the detection device 100 in its assembled form, the top housing 120 includes a window that provides access to a heat activation reservoir 170 of the integral heating element.

The heating element substrate 410 includes the heat activation reservoir 170 and a heating element cavity 865. A separation member 412 physically isolates the heat activation reservoir 170 from the heating element cavity 865, such that introduction of an agent into the heat activation reservoir 170 does not immediately come into contact with contents of the heating element cavity 865. The heating element substrate 410 also includes an overflow cavity 414. The overflow cavity 414 is configured to receive excess agent and/or gases that exceed the volume of the heating element cavity 865. One or more channels are formed between grooves 416 in the heating element substrate 410 and the sheet 820 when the sheet 820 is coupled to the heating element substrate 410. The one or more channels allow any excess agent and/or gases to flow from the heating element cavity 865 to the overflow cavity 414.

The wicking paper 850 is positioned within the heating element substrate 410, with a first portion of the wicking paper 850 positioned in the heat activation reservoir 170, and a second portion of the wicking paper 850 positioned in the heating element cavity 865. The wicking paper 850 includes a bridge portion 854 that extends over a separation member 412 of the heating element substrate. The separation member 412 separates the heat activation reservoir 170 from the heating element cavity 865, such that the introduction of a heat activating agent to the heat activation reservoir 170 does not immediately expose contents of the heating element cavity 865 to the heat activating agent.

The exothermic heating material 840 is positioned in the heating element cavity 865. The exothermic heating material 840 is positioned over and in contact with an upper surface 852 of the wicking paper 850. At the beginning of a test event, a heat activating agent is placed in the heat activation reservoir 170 shown in FIG. 1A. The heat activating agent can include a liquid, such as water, a buffer solution, or a reagent solution, a gas, a powder, or any other agent configured to activate the heat-generating component of the integral heating element.

The heat activating agent can be added to the heat activation reservoir 170 manually by a user or by an automated system. The heat activating agent can be added to the heat activation reservoir 170 before or after a sample is added to the sample reservoir 212. In one non-limiting embodiment, the heat activating agent is added to the heat activation reservoir 170 a pre-determined amount of time before the sample is added to the detection device 100, where the pre-determined amount of time is selected based on a time for the heat-generating element to be activated and generate a suitable or optimal quantity of heat. In one example, the heat activating agent is added 30 minutes, 25 minutes, 20 minutes, 15 minutes, 10 minutes, 5 minutes, 1 minute, 30 seconds, 10 seconds, 5 seconds, 1 second, or a time period within a range defined by any two of the aforementioned values, before the fluid sample is added to the detection device 100.

The heat activating agent received in the heat activation reservoir 170 interacts with the portion of the wicking paper 850 positioned in the reservoir 170. In one example in which the activating agent is a liquid, the wicking paper 850 absorbs the activating agent. The heat activating agent flows along or is wicked by the wicking paper 850 into the heating element cavity 865. The exothermic heating material 840 that is located in the heating element cavity 865 and in contact with the upper surface 852 interacts with the heat activating agent in this portion of the wicking paper 850. When the heat activating agent contacts the exothermic heating material 840, heat is generated. Heat generated by the exothermic heating material 840 is transmitted to the sheet 820 positioned above the heating element substrate 410. The sheet 820 can be formed of metal, such as but not limited to aluminum.

In this non-limiting example, the heating element includes a seal 830 positioned between the heating element substrate 410 and the sheet 820. The seal 830 can include an aluminum pressure sensitive adhesive (PSA) configured to seal the exothermic heating material 840 inside a space formed between the heating element cavity 865 and the sheet 820. The heating element can also include the white background material 810 positioned above the sheet 820. The heating element may also include the layer 870 positioned below the heating element substrate 410. The layer 870 can form a bottom surface of the heating element cavity 865.

The exothermic heating material 840 can be located within the heating element substrate 410 at a position directly beneath the control well 160, the reagent well 140, and the test well 150 located in the fluid flow path. As a result of this arrangement, heat generated by the exothermic heating material 840 is directed to the fluid sample located in these wells, thereby increasing the temperature of the fluid sample. Advantageously, increasing the temperature of the fluid sample in this manner can increase the rate of reactions in these wells, including the rate of reaction of the reducing agent 142 with the fluid sample, thereby shortening the assay reaction time or providing an ideal reaction temperature without the need for external equipment to provide heating.

The exothermic heating material can be any material capable of undergoing an exothermic chemical reaction upon contact with a heat activating agent. For example, the exothermic heating material can include calcium oxide (CaO), magnesium (Mg), iron (Fe), calcium chloride (CaCl₂)), or any combination thereof. The exothermic heating material can include a phase change material (PCM), which can include, for example, sodium acetate (NaOCOCH₃), paraffin, other salt hydrates, a fatty acid, or a combination thereof. The PCM can act as a buffer to prevent excessive heat generation.

Embodiments of the detection device that implement an integral heating element can include a resistive heating element. FIGS. 8B and 8C illustrate components of an exemplary integral resistive heating element 880 implemented in a detection device 900 according to the present disclosure. The detection device 900 can include the same or similar components of the detection device 100 (such as the top substrate 210, the bottom substrate 310, and related components), although these components are not illustrated in FIGS. 8B and 8C. FIG. 8B shows a resistive heating element 880 integrated into the bottom housing 110 of the detection device 900. The resistive heating element 905 include one or more resistive heaters 910, which are positioned on a printed circuit board (PCB) in a location directly beneath the control well 160, the reagent well 140, and the test well 150, thereby generating heat at these specific locations to increase temperature of the fluid sample in the control well 160, the reagent well 140, and the test well 150. The resistive heating element 905 includes a power source 920, which can include one or more battery holders and/or external power connections for providing power to the one or more resistive heaters 910.

FIG. 8C depicts the resistive heating element 880 without the bottom housing 110. The resistive heating element 880 can be removable and/or re-usable. For example, the resistive heating element 880 can be removed from a bottom housing 110 of a first detection device 900 and installed in a bottom housing 110 of a second detection device 900 after the completion of a test event using the first detection device 900.

Advantageously, activating the resistive heaters 910 can generate controlled, instantaneous heat that is quickly transmitted to test components. In one non-limiting example, the resistive heaters 910 are activated shortly before or shortly after the fluid sample is added to the detection device 900. For example, the resistive heaters 910 can be activated 1 minute, 50 seconds, 40 seconds, 30 seconds, 20 seconds, 10 seconds, 5 seconds, or 1 second before or after adding the sample to the detection device 900.

### Features of Example Detection Devices

Detection devices described herein include a device housing. The housing of any of the detection devices described herein, including the top housing or the bottom housing, may be made with any suitable material, including, for example, vinyl, nylon, polyvinyl chloride, polypropylene, polystyrene, polyethylene, polycarbonates, polysulfanes, polyesters, urethanes, or epoxies. The housing may be prepared by any suitable method, including, for example, by injection molding, compression molding, transfer molding, blow molding, extrusion molding, foam molding, thermoform molding, casting, layer deposition, or printing. In some embodiments, the top housing includes a viewing window to visualize a sample at the control well and at the test well. In some embodiments, the top housing includes a heat activation reservoir or well. In some embodiments, the top housing includes a locking feature for coupling to the cap. In some embodiments, the bottom housing includes a gas vent. In some embodiments, the top housing and the bottom housing include complementary posts and receptacles, which couple together such that the top housing and the bottom housing couple together in complementary fashion to house internal components, such as the fluid flow path and (if implemented) heating elements, of the detection device.

The cap of any of the detection devices described herein may be made with any suitable material, including, for example, vinyl, nylon, polyvinyl chloride, polypropylene, polystyrene, polyethylene, polycarbonates, polysulfanes, polyesters, urethanes, or epoxies. In some embodiments, the cap includes a flexible linker capable of linking the cap to the top housing or the bottom housing, and allowing the cap to move from an open position (FIG. 1A) to a closed position (FIG. 1B). In some embodiments, the cap includes an outer lip capable of locking to a locking feature to couple the cap to the detection device. In some embodiments, the inner features of the cap include a plunger configured to couple with the sample reservoir. The plunger is capable of removing excess fluid sample from the sample reservoir. In addition, upon closing the cap, the plunger is configured to generate pressure sufficient to drive or propel fluid sample through the fluid flow path in a precise, predetermined volume. In some embodiments, the plunger includes a seal for coupling to the sample reservoir. In some embodiments, the cap further includes an outer seal that prevents fluid leakage from the detection device, by retaining excess fluid in the overflow reservoir. In some embodiments, the plunger seal and/or the outer seal is an elastomeric seal.

Detection devices described herein can include a sample reservoir where a fluid sample is introduced to a fluid flow path. In one example, the sample may be introduced to the sample reservoir by external application, as with a dropper or other applicator. The sample may be poured onto the sample reservoir. In another example, the sample reservoir may be directly immersed in the sample. As described herein, the sample volume placed into the sample reservoir need not be a precise volume. Instead, an approximate volume of fluid sample may be placed in the sample reservoir. Upon closing the cap of the detection device, any excess fluid sample is removed into the overflow reservoir, and a precise, predetermined volume of fluid sample is propelled through the fluid flow path due to pressure exerted by the plunger integrated on the cap. Accordingly, the detection device includes automatic measurement of the fluid sample. Although a user need not measure a precise volume of fluid sample, a user can be instructed to add a minimum volume of fluid sample to the sample reservoir. For example, a fluid sample that is less than the minimum volume may be insufficient for the fluid sample to flow through the entire flow path, thereby resulting in inaccurate test results. It will be understood that the detection devices of the present disclosure can be shaped and sized to accept and test any suitable sample volume. In non-limiting examples, a volume of sample configured to flow through the fluid flow path can range from about 100 μL to about 500 μL, such as 100, 125, 150, 175, 200, 225, 250, 275, 300, 325, 350, 375, 400, 425, 450, 475, or 500 μL, or an amount within a range defined by any two of the aforementioned values. Accordingly, the volume can be in the microliter to the sub-milliliter range. This volume can be sufficient to completely fill the fluid flow path, the control well, the reagent well, and the test well in embodiments of the present disclosure. The volume of fluid sample flows through the fluid flow path, displacing inert gas or air present in the fluid flow path. The inert gas or air flows downstream in the direction of the fluid flow, through the fluid flow path, through the control well, through the one-way flapper valve, through the reagent well, through the test well, and through the gas vent, which may include a fit, thus venting out of the detection device.

Excess fluid sample (if any) results in a portion of the fluid sample flowing to the overflow reservoir, such that excess fluid sample is accommodated by and expressly contained within the detection device. The overflow reservoir may have a holding capacity ranging from 0.1 mL to 5 mL, such as 0.1, 0.2, 0.3, 0.4, 0.5, 0.6, 0.7, 0.8, 0.9, 1, 1.5, 2, 2.5, 3, 3.5, 4, 4.5, or 5 mL, or an amount within a range defined by any two of the aforementioned values. The holding capacity of the overflow reservoir can be any volume appropriate for receiving and retaining excess fluid sample, and capable of preventing leakage of the fluid sample from the detection device.

It will be understood that embodiments of the detection devices according to the present disclosure can be implemented without sample collection volume control features. In one non-limiting example, a detection device of the present disclosure receives a sample volume in a sample reservoir that does not interact with an overflow reservoir, a cap, or a plunger.

Accordingly, some embodiments provided herein relate to a detection device having sample collection volume control features. In some embodiments, the sample collection volume control includes a sample reservoir having a specified sample volume, an overflow reservoir configured to capture excess fluid sample, and a plunger that: 1) generates pressure to deliver a precise, predetermined volume of fluid sample through an assay fluid flow path; and 2) removes excess fluid sample from the sample reservoir into the overflow reservoir. Accordingly, delivery of a precise, pre-determined volume is built in to the dimensions of the detection device (including the shape, size, and volume of the sample reservoir and the shape, size, and volume of the plunger interacting with the sample reservoir), eliminating or reducing user error. In some embodiments, the fluid flow path includes a top substrate and a bottom substrate that couple together in a precise manner to provide a single integrated fluid flow path that transitions between the top substrate and the bottom substrate. The substrate may be made with any suitable material, including, for example, vinyl, nylon, polyvinyl chloride, polypropylene, polystyrene, polyethylene, polycarbonates, polysulfanes, polyesters, urethanes, or epoxies. Components that form portions of the fluid flow path, including the fluid channels, the junction points, and the wells (for example, the control well, reagent well, test well) may be manufactured in the substrate material using known manufacture techniques, such as injection molding, compression molding, transfer molding, blow molding, extrusion molding, foam molding, thermoform molding, casting, layer deposition, laser imprinting, or printing. After manufacture of the substrate, portions of the fluid flow path that are partially defined in the substrate (such as fluid channels and wells) are sealed using one or more layers adhered to the top and/or bottom surfaces of the substrate. The layers can include a sealing film integrated onto the device using any known method, such as laser sealing, heat sealing, adhesives, or other methods of attachment. The sealing film has sufficient seal burst pressure to contain a sample within the fluid flow path at pressures of up to 40 pounds per square inch (psi), such as 10, 15, 20, 25, 30, 35, or 40 psi, or in an amount within a range defined by any two of the aforementioned values. In some embodiments, the sealing film has sufficient transparency to allow a colorimetric measurement of the fluid sample at the control well and the test well, including optical transparency, or no interference by a reader device. In some embodiments, the sealing film is a 3M LF400M film (heat sealing) or a 3M 9982 film (pressure sensitive adhesive). Other acceptable films may also be used having desirable characteristics of high seal burst pressure, high transparency, compatibility with fluid samples, including reagents such as a dye and a reducing agent, and rapid seal curing time.

In some embodiments, the fluid flow path is integrated into a single substrate, as opposed to a top substrate and a bottom substrate. In a single substrate, the fluid flow path includes junction points allowing the fluid flow path to have upper or lower flow paths, such that the various wells, including the control well, the reagent well, and the test well can fill in a specified direction (from bottom to top or from the top to the bottom). Whether in a single substrate or integrated through two or more substrates, the design of the fluid flow path provides several advantages, including passage of the fluid sample first to a control well, and passage of the fluid sample through a one-way flapper valve, which separates a control zone (fluid flow path upstream of the one-way flapper valve) from a test zone (fluid flow path downstream of the one-way flapper valve), such that fluid sample cannot flow from the test zone to the control zone. Once the fluid sample passes through the one-way flapper valve into the test zone, the fluid sample cannot travel back into the control zone. The fluid flow path also provides the advantage of filling wells from a particular direction, such as from top to bottom or from bottom to top.

With reference to FIG. 4A, a fluid sample is placed in a sample reservoir, and solubilizes a dye contained therein. The fluid sample can be any fluid sample having or suspected of having any analyte of interest therein. The analyte of interest may include, for example, an antineoplastic agent, such as cyclophosphamide, docetaxel, fluorouracil, ifosfamide, imatinib, or paclitaxel. The dye can include any dye capable of undergoing a detectable color change in the presence of the analyte of interest in combination with a reducing agent. For example, the dye can be direct red 2, direct red 7, direct red 13, direct red 53, direct red 75, direct red 80, direct red 81, direct fast red B, methylene blue, methyl orange, crocein scarlet 7B, Congo red, or an azo dye. In some embodiments, reaction of the dye with a reducing reagent in the presence of analyte clarifies the dye, such that the fluid sample with dye exhibits a strong color of dye, whereas fluid sample with dye and reducing agent with analyte exhibits a reduced color of dye. In some embodiments, the dye is direct red 13, and the reducing agent is NaBH₄. Without wishing to be bound by theory, in the presence of a platinum-containing drug, a reducing agent results in the formation of platinum nanoparticles, and reduces the dye. The dye reaction is based on reduction of the azo bonds, which occurs at a slow rate, and is catalyzed in the presence of platinum nanoparticles. The reducing agent also reacts in the presence of water to produce hydrogen, which results in generation of gas buildup in the reagent well, increasing pressure in the reagent well, and propelling the fluid sample to the test well. The rate of the reaction may be modified based on the temperature of the assay. The temperature may be performed at room temperature (or at the environmental temperature in which the reaction is being performed), or at elevated temperatures. For example, the devices described herein may further include an integral heating element, as described in greater detail herein. Increased temperatures increase the reaction of the reducing reagent with water, and increases the hydrogen production.

Although embodiments of the detection device of the present disclosure are described as detecting platinum-based antineoplastic drugs, it will be understood that the present disclosure is not limited to this example implementation. Embodiments of the detection device of the present disclosure can also detect other analytes of interest, such as but not limited to palladium-based drugs (for example palladium(ii) complexes with thiosemicarbazones), ruthenium-based drugs, and gold-containing drugs (for example, auranifin, aurothioglucose, sodium aurothiosulfate, di sodium aurothiomalate, sodium aurothiomalate, and various other drugs including gold salts). Additionally, although embodiments of the detection device of the present disclosure are described as implementing NaBH₄ as a reducing agent, it will be understood that the present disclosure is not limited to this example implementation. Embodiments of the detection device of the present disclosure can implement other reducing agents, for example but not limited to reducing agents in the borohydride family, LiAlH₄, and Zn(BH₄)₂.

In some embodiments, the dye is dried onto the walls of the sample reservoir. The dye, upon solubilization, in this embodiment, may be between 50 to 200 μM concentration. It is understood that varying well and/or sample fluid volumes and/or properties would involve adjustments to the level of dried and solubilized dye. For example, in a 100 μL sample reservoir with high dye release properties would have 10 μL of 1000 mM dye dried to yield a solution with 100 mM dye. The fluid sample solubilizes the dye, and upon application of the plunger, the fluid sample having dye solubilized therein begins to flow down the fluid channel. The fluid channel can include a mixing feature, having irregularly-shaped side walls and posts therein to promote mixing of the fluid sample with the dye. In some embodiments, the dye is added to the fluid sample prior to placing the fluid sample in the detection device. In another non-limiting, the dye is added to sample reservoir after the sample is added to the sample reservoir. The fluid sample flows along a flow path to a control well. A non-limiting example flow path is described in greater detail above, but it will be understood that alternative flow paths can be suitably implemented in embodiments of the present disclosure Fluid sample in the control well exhibits a control color due to the presence of the dye, such that the control color can be colorimetrically measured visually by an operator or by a detector positioned to receive optical signals at the control well.

Embodiments of detection devices described herein include a one-way flapper valve in the fluid flow path. It will be understood that embodiments of the detection device of the present disclosure can be suitably implemented without a valve. The valve can also act as a junction point to transition the fluid sample from an upper substrate to a bottom substrate. In one non-limiting example, the one-way flapper valve includes a valve assembly, which has a flapper relief cavity allowing fluid sample to flow through the one-way flapper valve in a downstream direction only. The one-way flapper valve can include a support ring and a displacing flapper. The one-way flapper valve can be made of any suitable material including, for example, vinyl, nylon, polyvinyl chloride, polypropylene, polystyrene, polyethylene, polycarbonates, polysulfanes, polyesters, urethanes, or epoxies. In some embodiments, the one-way flapper valve is a hydrogel or other swelling material. After fluid sample has flowed through the one-way flapper valve, it remains downstream of the one-way flapper valve, and cannot travel upstream (or back through) the one-way flapper valve. Thus, the one-way flapper valve is configured to prevent backflow of the fluid sample.

The fluid sample flows through the one-way flapper valve to the reagent well. The reagent well includes a reagent deposited therein. In some embodiments, the reagent is a reducing agent, such as NaBH₄. The reducing agent can be dried into the reagent well during or after manufacture of the substrate. An amount of reducing agent dried in the reagent well may be in an amount that is equivalent to 10 mM to about 1000 mM, such as 10, 20, 30, 40, 50, 60, 70, 80, 90, 100, 150, 200, 250, 300, 350, 400, 450, 500, 550, 600, 650, 700, 750, 800, 850, 900, 950, or 1000 mM, or an amount within a range defined by any two of the aforementioned values. The fluid sample flows into the reagent well from the bottom of the reagent well, solubilizing the reducing agent. If analyte is present in the fluid sample, the dye reacts with the reducing agent to create two distinct chemical reactions. A first chemical reaction is a color change of the dye, which undergoes a color change to a test color that is distinguishable from the control color. A second chemical reaction is generation of a gas, which generates pressure and propels the fluid sample to the test well. The filling of the test well from the pressure buildup of gas generated in the reagent well allows for lower sealing pressure requirements, and prevents undesirable artifacts, such as bubbles or debris, from entering the test well. These artifacts may cause anomalies in measuring the signal at the test well, and the elimination of artifacts results in improved measurements. Accordingly, the gas generation at the reagent well reduces artifacts, such as bubble formation in the test well, thereby improving measurement of the color of fluid sample at the test well. Additional methods can be used to prevent bubble adhesion in the test well, including plasma treating the test well such that the walls of the test well undergo surface modifications of the substrate material to decrease bubble adhesion in the test well. At the same time, the reagent well is not similarly treated, which promotes adhesion of bubbles to the reagent well. The result is a volumetric expansion of gas in the reagent well, which propels fluid sample into the test well without bubbles, resulting in a clearer test well for improved imaging of the fluid sample. The fluid sample fills the test well from the bottom to the top.

In embodiments of the present disclosure, the gas or air that filled the entire fluid flow path before placement of fluid in the fluid flow path is pushed through the fluid flow path through a gas vent downstream of the test well. The gas vent can include a self-sealing frit, such as a Porex frit, that allows passage of gas, such as air present in the fluid flow path. If excess fluid sample flows out of the test well to the gas vent, the frit in the gas vent is configured to prevent flow of fluid sample past the gas vent to the surrounding atmosphere. In some embodiments, the Porex frit is a Porex 5422 35 μm polyethylene self-sealing material.

The flow of the sample from the sample reservoir, through the entire flow path to the reagent well, takes place due to the placement of the cap over the sample reservoir, as the plunger in the cap generates pressure that propels a predetermined and specific volume of fluid sample through the flow path. Upon reaching the reagent well, the fluid sample contacts the reducing agent, which generates a gas. The generation of gas increases pressure at the reagent well. The fluid sample cannot flow upstream, due to the one-way flapper valve, and thus, the fluid sample travels in a single direction toward the test well, which can be treated to prevent or decrease bubble adhesion. Upon completion, fluid sample in the control well exhibits a control color, and fluid sample in the test well exhibits a test color, if the analyte of interest is present in the fluid sample. The control color at the control well and the test color at the test well may be measured colorimetrically or optically, such as by visual inspection or by measuring with a reader device to determine whether the color at the control well and the color at the test well are the same or different. A determination that the colors are different is indicative that analyte is present in the fluid sample, whereas a determination that the colors are identical (or within a pre-determined range of color variation) is indicative that analyte is not present in the fluid sample. Where colors are determined to be different, the degree of difference may be measured to determine a quantity of analyte present in the sample.

The control well and the test well are visible in a viewing window in the top housing, such that after the fluid sample has flowed through the detection device, the control well and the test well can be measured. Measurement can take place by visual inspection of the colors at the control well and at the test well, or by placing the detection device in a reader device that is capable of measuring optical properties (e.g. color, absorbance, transmittance, reflectance) at the control well and the test well. In some embodiments, the reader device is configured to compare the reflectance or absorbance signal at the control well with the reflectance or absorbance signal at the test well, and generate a value indicative of a difference in a signal from the control well and a signal from the test well. In some embodiments, the reader device is capable of quantifying an amount of analyte present in the fluid sample based on the difference between the signal at the control well and the signal at the test well.

In some embodiments, the detection device further includes a heating element. In some embodiments, the heating element is a chemical heating element or a resistive heating element. In some embodiments, the heating element is an integrated heating element that is positioned within the housing at a location directly beneath the fluid flow path, in a position that is capable of specifically modulating the temperature of the fluid sample in the control well, the reagent well, and the test well. It will be understood that other spatial arrangements can be implemented, such as placing the heating element above or laterally adjacent to the fluid flow path. In some embodiments, the heating element modulates the temperature of the fluid sample to decrease the assay reaction time or to provide an ideal reaction temperature.

In some embodiments, the heating element is a chemical heating element. In embodiments when the heating element is a chemical heating element, the top housing includes a heat activation reservoir, which is configured to receive an activation agent that is capable of activating an exothermic reaction. The activation agent can be any agent capable of activating an exothermic reaction, such as air, water, buffer, or a fluid. The activation agent is deposited in the heat activation reservoir, and contacts the chemical heating element, thereby generating an exothermic reaction, increasing the temperature of the chemical heating element, and in turn, increasing the temperature of the fluid sample flowing through the fluid flow path. In some embodiments, the activation agent is deposited into a heating element reservoir. In some embodiments, a wicking layer (such as wicking paper) is deposited in the heating element reservoir. The wicking paper is made of any suitable material capable of wicking the heating activation agent in a controlled manner to the chemical heating element, thereby controlling the reaction rate. For example, the wicking paper is a cellulosic material, a paper substrate, a fiber material, or other suitable material. In some embodiments, the wicking paper has a portion located in the heating element reservoir, and has a bridge portion that extends over a separation member that separates the heating element reservoir from a heating element cavity. The activation agent flows through the wicking paper, over the bridge portion, into the heating element cavity, where it contacts the chemical heating element, thereby activating an exothermic reaction.

The chemical heating element can be made of any suitable material capable of undergoing an exothermic reaction. For example, the chemical heating element can include calcium oxide, magnesium, iron, calcium chloride, sodium acetate, or combination, salts, or derivatives thereof. For example, water oxidation of magnesium is a thermodynamic source of heat, and the presence of sodium chloride and iron kinetically enhances the reaction rate sufficient to generate heat. In some embodiments, the chemical heating element further includes a phase change material (PCM) that acts as a buffer to prevent the reaction temperature from excessive elevation.

The chemical heating element can generate heat in an amount greater than about 0.2 kJ/g to about 30 kJ/g, such as an amount greater than 0.2, 0.4, 0.6, 0.8, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 kJ/g, or greater, or an amount within a range defined by any two of the aforementioned values. In some embodiments, the chemical heating element includes calcium oxide, which reacts with water for an exothermic heat output of about 1.15 kJ/g. In some embodiments, the chemical heating element includes magnesium/iron alloy, which reacts with water for an exothermic heat output of about 14.52 kJ/g. A magnesium/iron alloy may have a ratio of magnesium to iron in an amount of 1:5, 1:4, 1:3, 1:2, 1:1, 2:1, 3:1, 4:1, 5:1, 2:3, 2:5, 3:2, 5:2, or in an amount within a range defined by any two of the aforementioned values. In some embodiments, the chemical heating element includes calcium chloride, which reacts with water for an exothermic heat output of about 0.73 kJ/g. In some embodiments, the chemical heating element includes iron plus salt, which reacts with oxygen and/or water to for an exothermic heat output of about 29.52 kJ/g. In some embodiments, the PCM includes sodium acetate and/or paraffin, which melts or solidifies to control or temper the temperature increase. The ratio of chemical heating element, such as Mg/Fe alloy to PCM can be used at various ratios, such as 1:5, 1:4, 1:3, 1:2, 1:1, 2:1, 3:1, 4:1, 5:1, 2:3, 2:5, 3:2, 5:2, or in an amount within a range defined by any two of the aforementioned values. Other chemical heating elements may be used.

In some embodiments, the chemical heating element further includes an aluminum pressure sensitive adhesive (PSA), an aluminum sheet, and/or a heat dissipation material for controlling and/or conducting the heat to the appropriate locations of the fluid flow path. In some embodiments, the chemical heating element further includes on overflow cavity, wherein excess activation agent can flow, and can further include venting holes, allowing venting of air or gases from the chemical heating element.

In some embodiments, the heating element is one or more resistive heating elements. The resistive heating elements are housed within the detection device housing, in a location directly beneath the fluid flow path. It will be understood that other spatial arrangements can be implemented, such as placing the heating element above or laterally adjacent to the fluid flow path. The resistive heating element may include a printed circuit board (PCB), having resistive heaters printed thereon that are located directly beneath the control well, the reagent well, and the test well. A power source configured to provide an electrical current to the resistive heaters can be housed within the same enclosure as the PCB or can be located external to the housing. The power source may be, for example, a small coin cell battery or an external power source. The heaters on the PCB can be activated in any number of ways, including, for example, a mechanical switch that trips during user action, such as placement of the cap on the sample reservoir, opening a package, or manually switching a mechanical switch, or by closing a conductive trace on the PCB when the device is filled with fluid sample (for example, the fluid conductivity of the fluid sample completes the electrical path). In one embodiment, the resistive heating element is a single-use device that is disposed after the detection device is operated. In another embodiment, the resistive heating element is removably received in the detection device such that it can be removed after the detection device is operated, and reused in multiple detection devices for generation of heat in multiple devices.

In some embodiments, the heating element generates a heat capable of increasing the temperature of the fluid sample in the fluid flow path to a temperature ranging from about 20° C. to about 60° C., such as 20, 25, 30, 35, 40, 45, 50, 55, or 60° C., or to a temperature within a range defined by any two of the aforementioned values. In some embodiments, the heating element increases the temperature of the fluid sample within a time ranging from about 1 minute to about 10 minutes, such as 1, 2, 3, 4, 5, 6, 7, 8, 9, or 10 minutes, or in an amount of time within a range defined by any two of the aforementioned values. In some embodiments, the heating element is configured to maintain the temperature of the fluid sample for a time period ranging from about 5 minutes to about 60 minutes, such as 5, 10, 15, 20, 25, 30, 35, 40, 45, 50, 55, or 60 minutes, or for a time period within a range defined by any two of the aforementioned values. In some embodiments, the increase of temperature of the fluid sample does not affect the sensitivity of the detection means, such as a visual detection of the signal at the control well and at the test well, or the reader device. Advantages of a heating element include providing an internal heating source that is integrated into the detection device, thereby avoiding a requirement for external heating sources, such as a secondary heating device or incubation oven. Further, having an internal heating element as described herein, the detection device can retain the existing size and shape of conventional or standard detection devices, such that no modification is required for reader devices to be able to read results of an assay performed on the detection device.

### Example Methods of Detecting Analyte

Embodiments provided herein relate to methods of detecting an analyte in a fluid sample using the detection device provided herein. In some embodiments, the analyte is an agent to be detected that is obtained from an environmental source. In some embodiments, the analyte is a hazardous contaminant obtained from an environmental source. The analyte may be obtained from any surface found within any environment where an analyte is typically found or suspected of being found. For example, the analyte may be an analyte that is found in a hospital, health care, clinical, research, pharmacy, forensic, or industrial environment. The analyte may be an analyte found in a domestic or residential setting. The analyte may be obtained from a surface in a hospital, health care facility, clinic, research facility, or pharmacy, such as from a surface of a bench, desk, counter, cabinet, wall, floor, window, instrument (such as but not limited to a compounding hood), appliance (such as but not limited to a refrigerator and a freezer), table, chair, toilet or bed found within the environment (including any surface or handle associated with any of the aforementioned areas and objects). The above list of potential areas and objects from which the analyte can be obtained is meant to be illustrative and is not exhaustive. The analyte may be measured by the user that collects the quantity of analyte, or the analyte may be obtained by an upstream user, who then provides the analyte to an operator who measures the analyte in the sample.

The analyte may be present in a sample ranging in an amount from less than 1 nM to more than 1000 nM, such as less than 1, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 550, 600, 650, 700, 750, 800, 850, 900, 950, or 1000 nM, or in an amount within a range defined by any two of the aforementioned values.

As used herein, “analyte” generally refers to a substance to be detected. For instance, analytes may include antigenic substances, haptens, antibodies, and combinations thereof. Analytes of interest include, but are not limited to, antineoplastic agents, gold salts, steroids, toxins, organic compounds, proteins, peptides, microorganisms, amino acids, nucleic acids, hormones, steroids, vitamins, drugs (including those administered for therapeutic purposes as well as those administered for illicit purposes), drug intermediaries or byproducts, bacteria, virus particles, and metabolites of or antibodies to any of the above substances. Drugs of abuse and controlled substances include, but are not intended to be limited to, amphetamine; methamphetamine; barbiturates, such as amobarbital, secobarbital, pentobarbital, phenobarbital, and barbital; benzodiazepines, such as librium and valium; cannabinoids, such as hashish and marijuana; cocaine; fentanyl; LSD; methaqualone; opiates, such as heroin, morphine, codeine, hydromorphone, hydrocodone, methadone, oxycodone, oxymorphone and opium; phencyclidine; and propoxyhene. Additional analytes may be included for purposes of biological or environmental substances of interest. It will be understood that embodiments of the present disclosure can be implemented to detect any suitable analyte of interest.

In some embodiments, the analyte of interest is an antineoplastic agent. As used herein the term “antineoplastic agent” has its ordinary meaning as understood in light of the specification, and refers to agents that have the functional property of inhibiting a development or progression of a neoplasm in a human, particularly a malignant (cancerous) lesion, such as a carcinoma, sarcoma, lymphoma, or leukemia. Inhibition of metastasis is frequently a property of antineoplastic agents. In some embodiments, the analyte of interest is afatinib, aflibercept, alemtuzumab, alitretinoin, altretamine, anagrelide, arsenic trioxide, asparaginase, axitinib, azacitidine, BCG vaccine, bendamustine, bevacizumab, bexarotene, bosutinib, bleomycin, bortezomib, busulfan, cabazitaxel, capecitabine, carboplatin, carmofur, carmustine, cetuximab, chlorambucil, cisplatin, cladribine, clofarabine, crizotinib, cyclophosphamide, cytarabine, dacarbazine, dactinomycin, dasatinib, daunorubicin, decitabine, denileuikin diftitox, denosumab, docetaxel, doxorubicin, epirubicin, erlotinib, estramustine, etoposide, everolimus, floxuridine, fludarabine, fluorouracil, fotemustine, gefitinib, gemcitabine, gemtuzumab ozogamicin, hydroxycarbamide, ibritumomab tiuxetan, idarubicin, ifosfamide, imatinib, ipilimumab, irinotecan, isotretinoin, ixabepilone, lapatinib, lenalidomide, lomustine, melphalan, mercaptopurine, methotrexate, mitomycin, mitoxantrone, nedaplatin, nelarabine, nilotinib, nivolumab, ofatumumab, oxaliplatin, paclitaxel, panitumumab, panobinostat, pazopanib, pembrolizumab, pemetrexed, pentostatin, pertuzumab, pomalidomide, ponatinib, procarbazine, raltitrexed, regorafenib, rituximab, romidepsin, ruxolitinib, sorafenib, streptozotocin, sunitinib, tamibarotene, tegafur, temozolomide, temsirolimus, teniposide, thalidomide, tioguanine, topotecan, tositumomab, trastuzumab, tretinoin, valproate, valtubicin, vandetanib, vemurafenib vinblastine, vincristine, vindesine, vinflunine, vinorelbine, or vorinostat, or any derivative, conjugate, or analogue thereof.

In some embodiments, the analyte is a steroid. In some embodiments, the steroid is a glucocorticoid and includes, for example, hydroxycortisone, cortisone, desoxycorticosterone, fludrocortisone, betamethasone, beclometasone, dexamethasone, prednisolone, prednisone, methylprednisolone, paramethasone, triamcinolone, flumethasone, fluocinolone, fluocinonide, fluprednisolone, halcinonide, flurandrenolide, meprednisone, medrysone, clobetasol, and esters, mixtures, analogues, or derivatives thereof.

In some embodiments, the analyte is a toxin. As used herein, the term “toxin” has its ordinary meaning as understood in light of the specification, and refers to an agent exhibiting poisonous properties to living cells or organisms. Toxins may include, for example, small molecules, peptides, or proteins, and may include biotoxins or environmental toxins.

In some embodiments, the analyte is a pesticide. As used herein, the term “pesticide” has its ordinary meaning as understood in light of the specification, and refers to an agent or agents that controls pests. Pesticides may include, for example, algicides, antifouling agents, antimicrobials, attractants, biopesticides, biocides, disinfectants, fungicides, fumigants, herbicides, insecticides, miticides, microbial pesticides, molluscicides, nematicides, ovicides, pheromones, repellents, or rodenticides.

In some embodiments, the analyte is a biowarfare agent, which may include, for example, a biological toxin, an infectious agent, such as a bacteria, virus, or fungi, or other agent intended for killing or harming biological organisms, such as humans, animals, or plants.

In some embodiments, the analyte is obtained from a test surface using a collection device. As described herein, a test surface is any surface where any analyte of interest as described herein may be obtained, or where any analyte may be suspected of being found. In non-limiting examples, the test surface can be a surface of any object found in a hospital, health care facility, clinic, research facility, or pharmacy. In some embodiments, the test surface is a surface of a bench, desk, counter, cabinet, wall, floor, window, instrument, table, chair, toilet or bed found within the environment.

In some embodiments, the analyte is obtained using a collection kit, which may include, for example, a buffer solution configured to solubilize, transport, or remove an analyte from a test surface when the buffer solution is applied to the test surface, and an absorbent swab material configured to absorb at least a portion of the buffer solution and to contact the test surface to collect the analyte. In some embodiments, the absorbent swab material is coupled to a first end of a handle. In some embodiments, the handle has a second end spaced apart from the first end, and an elongate length extending therebetween. In some embodiments, the collection kit further includes a fluid-tight container having an interior volume dimensioned to encase the handle and the absorbent swab material and the buffer solution, the container having a nozzle including an orifice sized to provide controlled release of a volume of the buffer solution from the interior volume. In one non-limiting example, an operator dispenses a volume of buffer solution from the container into the sample reservoir of a detection device of the present disclosure.

In some embodiments, the collected fluid sample, having or suspected of having an analyte in the fluid sample is deposited into any one of the detection device described herein at the sample reservoir. The volume of fluid sample deposited into the sample reservoir need not be measured prior to depositing the fluid sample into the sample reservoir. A user can deposit the fluid sample into the sample reservoir to completely fill the sample reservoir. In some embodiments, closing the cap of the detection device activates a plunger located on the cap, which propels a precise, predetermined volume of fluid sample through the fluid flow path of the detection device. Simultaneously, excess fluid sample, if present, that does not flow through the fluid flow path is pushed into an overflow reservoir. In some embodiments, closing the cap activates a mechanical switch on a resistive heating element, thereby simultaneously activating the resistive heating element at the time of initiating the detection assay.

In some embodiments, the methods further include measuring a control signal at the control well of the detection device and measuring a test signal at the test well of the detection device. In some embodiments, measurement may be performed visually, by visually inspecting the color at the control well and at the test well, wherein when the color at the control well and test well are identical, no analyte is present in the fluid sample, whereas when the color at the control well and test well differ from one another, analyte is present in the fluid sample. In some embodiments, measurement may be performed using a reader device. A reader device may include any reader device capable of receiving any one of the detection devices provided herein. The reader device may be capable of qualitative or quantitative measurement of an analyte in the fluid sample. A qualitative measurement may include a determination of whether the analyte is present in the sample or not. A quantitative measurement may include a determination of how much analyte is present in the sample. The devices, methods, and systems described herein may be capable of detecting and quantifying an analyte present in an amount ranging from about 1 nM to about 1000 nM, such as 1, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 550, 600, 650, 700, 750, 800, 850, 900, 950, or 1000 nM, or in an amount within a range defined by any two of the aforementioned values. The reader can be a conventional reader, and can be performed in a point-of-care setting or an off-site laboratory facility.

In some embodiments, measurement of the dye at the control well and at the test well is performed at a time period of less than 1 minute to less than 60 minutes after placement of the fluid sample on the detection device, such as less than 1, 2, 3, 4, 5, 6, 7, 8, 9, 10, 15, 20, 25, 30, 35, 40, 45, 50, 55, or 60 minutes, or in an amount of time within a range defined by any two of the aforementioned values. The amount of time can be reduced when an integrated heating element is present in the detection device.

### Example Test Systems

Detection device test systems described herein can include any one of the detection devices described herein, a system housing including a port configured to receive all or a portion of the detection device, a reader including a light source and a light detector, a data analyzer, and combinations thereof. A system housing may be made of any one of a wide variety of materials, including plastic, metal, or composite materials. The system housing forms a protective enclosure for components of the detection device test system. The system housing also defines a receptacle that mechanically registers the detection device with respect to the reader. The receptacle may be designed to receive any one of a wide variety of different types of detection devices. In some embodiments, the system housing is a portable device that allows for the ability to perform detection assay in a variety of environments, including on the bench, in the field, in the home, or in a facility for domestic, commercial, or environmental applications.

A reader may include one or more optoelectronic components for optically inspecting the control well and test well at the viewing window in the detection device. In some implementations, the reader includes at least one light source and at least one light detector. In some embodiments, the light source may include a semiconductor light-emitting diode and the light detector may include a semiconductor photodiode. Depending on the nature of the dye that is used in the detection device, the light source may be designed to emit light within a particular wavelength range or light with a particular polarization. For example, the dye may be a colorimetric dye, a fluorescent dye, or a reflective-type dye. For example, the dye can be direct red 2, direct red 7, direct red 13, direct red 53, direct red 75, direct red 80, direct red 81, direct fast red B, methylene blue, methyl orange, crocein scarlet 7B, or Congo red. Various azo dyes can be suitably implemented. It will be understood that each type of dye has a different operating range of solubility and concentration, as well as interaction with the reaction, and that the quantity and solubility of the selected dye can be optimized in implementations of the detection device of the present disclosure. The dye is configured to be one color, and changes a color to a second color when contacted with a reducing agent and in the presence of analyte. To these ends, the light detector may include one or more optical filters that define the wavelength ranges or polarizations axes of the captured light. A signal from a dye can be analyzed, using visual observation or a spectrophotometer to detect color in the control well and the test well, a colorimeter, or a fluorimeter to detect fluorescence in the presence of light of a certain wavelength. Detection devices described herein can be automated or performed robotically, if desired, and the signal from multiple samples in multiple detection devices can be detected simultaneously.

The data analyzer processes the signal measurements that are obtained by the reader. In general, the data analyzer may be implemented in any computing or processing environment, including in digital electronic circuitry or in computer hardware, firmware, or software. In some embodiments, the data analyzer includes a processor (e.g., a microcontroller, a microprocessor, or ASIC) and an analog-to-digital converter. The data analyzer can be incorporated within the housing of the diagnostic test system. In other embodiments, the data analyzer is located in a separate device, such as a computer, that may communicate with the diagnostic test system over a wired or wireless connection. The data analyzer may also include circuits for transfer of results via a wireless connection to an external source for data analysis or for reviewing the results.

Test systems can include a results indicator. In general, the results indicator may include any one of a wide variety of different mechanisms for indicating one or more results of an assay test. In some implementations, the results indicator includes one or more lights (e.g., light-emitting diodes) that are activated to indicate, for example, the completion of the assay test. In other implementations, the results indicator includes an alphanumeric display (e.g., a two or three character light-emitting diode array) for presenting assay test results.

Test systems described herein can include a power supply that supplies power to the active components of the diagnostic test system, including the reader, the data analyzer, the results indicator, and/or the heating element (where the heating element is a resistive heating element). The power supply may be implemented by, for example, a replaceable battery or a rechargeable battery. In other embodiments, the diagnostic test system may be powered by an external host device (e.g., a computer connected by a USB cable).

The following non-limiting examples illustrate features of detection devices, test systems, and methods described herein, and are in no way intended to limit the scope of the present disclosure.

### Example 1

### Preparation of a Detection Device According to the Present Disclosure

The following example describes preparation of a detection device according to the present disclosure to measure analyte present in an environmental sample. In this non-limiting example, the analyte is a platinum-based antineoplastic drug.

The detection device is prepared by preparing a top substrate and a bottom substrate, each of the top and bottom substrates having a fluid flow path integrated therein. The top and bottom substrates are configured to couple together such that the fluid flow path is fully integrated into a single fluid flow path running through the top and bottom substrate. The top substrate and the bottom substrate are coupled together using an ultrasonic weld. The top substrate is prepared having a sample reservoir. Deposited into the sample reservoir is a dye, that is dried in the sample reservoir. The bottom substrate is prepared having a control well, a flapper valve assembly, a reagent well, a test well, and a gas vent. The reagent well is prepared having a reducing agent deposited therein, which is dried in the reagent well. To prepare the reducing agent as a dried reagent, granules of sodium borohydride are dissolved in dry acetonitrile with sonification. The acetonitrile is dispensed to the reagent well, and the solvent is removed by flowing dry nitrogen. The amount of sodium borohydride dried into the reagent well is an amount equivalent to 20 mM to 40 mM in liquid concentration. The gas vent is prepared having a frit deposited therein. The test well is plasma treated for surface modification of the test well to decrease bubble adhesion to the sidewalls of the test well.

A top layer and a bottom layer are heat sealed to surfaces of the top and bottom substrates as described herein. The top layer and the bottom layer can include films, such as transparent films. A white background may be placed under the control well and the test well, in between the bottom substrate and the bottom layer, to provide a homogenous white background for improved detection of a signal.

After the fluid flow path is assembled, a heating element is inserted into or added to the bottom housing, the fluid flow path is inserted above the heating element, the cap with a plunger is inserted into the bottom housing, and the top housing is attached to the bottom housing.

### Example 2

### Detection of Analyte Using Detection Device

The following example demonstrates the use of the detection device described in Example 1 for detecting an environmental contaminant.

An environmental contaminant is obtained from an environmental source using a collection device. Briefly, an environmental contaminant present in a hospital or pharmacy environment is obtained by contacting a test surface with a buffer solution. After incubating for a short period, the buffer solution on the test surface is absorbed on an absorbent swab material. The absorbent swab material is inserted into a fluid-tight container. The solution is then transferred to the sample reservoir of the detection device, and the cap on the detection device is inserted over the sample reservoir.

Where the detection device includes a chemical heating element, an activation agent (water, buffer, or any other suitable fluid) is deposited into the heat activation reservoir, activating the chemical heating element. Where the detection device includes a resistive heating element, placement of the cap over the sample reservoir activates the resistive heating element in one example. Activation of the heating element (if present) can be performed before or after the solution is transferred to the sample reservoir.

The detection device is placed in a reader device, and a measurement of signal at the control well and at the test well is performed, and signals compared. A determination of the presence and/or quantity of analyte in the fluid sample is made.

It is to be understood that the description, specific examples and data, while indicating exemplary embodiments, are given by way of illustration and are not intended to limit the various embodiments of the present disclosure. Various changes and modifications within the present disclosure will become apparent to the skilled artisan from the description and data contained herein, and thus are considered part of the various embodiments of this disclosure.

1. A detection device for detecting an analyte in a fluid sample comprising:
a sample reservoir in fluid communication with a fluid flow path, wherein the fluid flow path comprises;
a control well downstream of the sample reservoir;
a valve assembly downstream of the control well;
a reagent well downstream of the valve assembly, the reagent well comprising a reducing agent dried therein; and
a test well downstream of the reagent well.

2. The device of claim 1, wherein the reducing agent is configured to react with a detection dye in the presence of the analyte to initiate a color change.

3. The device of claim 1, wherein the reducing agent is configured to generate a gas in the reagent well when the analyte is present in the fluid sample, the gas generated in the reagent well configured to propel the fluid sample from the reagent well into the test well.

4. The device of claim 3, wherein the valve assembly comprises a one-way valve configured to allow the fluid sample and the gas generated in the reagent well to move from the reagent well towards the test well, and to prevent the fluid sample and the gas generated in the reagent well from moving upstream of the one-way valve.

5. The device of claim 1, wherein the sample reservoir comprises a detection dye dried therein.

6. The device of claim 5, wherein the detection dye is configured to solubilize into the fluid sample when the fluid sample is added to the sample reservoir, and wherein the reducing agent is configured to react with the solubilized detection dye when the analyte is present in the fluid sample.

7. The device of claim 5, wherein the fluid flow path comprises a mixing feature downstream of the sample reservoir, the mixing feature comprising a plurality of posts disposed in the fluid flow path, the plurality of posts configured to promote mixing of the fluid sample with the detection dye when the fluid sample is added to the sample reservoir.

8. The device of claim 5, wherein the detection dye is direct red 2, direct red 7, direct red 13, direct red 53, direct red 75, direct red 80, direct red 81, direct fast red B, methylene blue, methyl orange, crocein scarlet 7B, Congo red, or an azo dye.

9. The device of claim 1, wherein the analyte is a platinum-based antineoplastic drug.

10. The device of claim 9, wherein the platinum-based antineoplastic drug comprises cisplatin, carboplatin, oxaliplatin, nedaplatin, triplatin tetranitrate, ormaplatin, phenanthriplatin, picoplatin, pyriplatin, or satraplatin, or analogues or derivatives thereof.

11. The device of claim 1, further comprising an overflow reservoir arranged concentrically around the sample reservoir.

12. The device of claim 1, further comprising a cap, wherein the cap comprises an outer seal and an activation plunger comprising an inner seal.

13. The device of claim 12, wherein the activation plunger is configured to sealably couple with the sample reservoir, and configured to propel a pre-determined volume of fluid sample through the fluid flow path.

14. The device of claim 1, wherein the reducing agent is NaBH₄.

15. The device of claim 1, further comprising a gas vent downstream of the test well, wherein the gas vent is configured to allow gas in the fluid flow path to evacuate the device after the fluid sample is added to the sample reservoir and begins to flow in the fluid flow path.

16. The device of claim 15, wherein the gas vent comprises a frit configured to seal to the passage of gas and the fluid sample in the presence of the fluid sample.

17. The device of claim 1, further comprising a top substrate comprising portions of the fluid flow path and a bottom substrate comprising portions of the fluid flow path, and wherein the fluid flow path further comprises a plurality of junction points when the top substrate is coupled to the bottom substrate, the plurality of junction points configured to move the fluid sample between the top substrate and the bottom substrate as the fluid flows from the sample reservoir to the test well.

18. The device of claim 1, further comprising a housing comprising a viewing window positioned above a top surface of the test well and a top surface of the control well, wherein optical signals read through the viewing window from the test well are different than optical signals read through the viewing window from the control well when the analyte is present in the fluid sample.

19. The device of claim 18, further comprising a heating element substrate comprising a heat activation reservoir, wherein a top surface of the heat activation reservoir is generally coplanar with the top surface of the test well and the top surface of the control well, the housing further comprising an access window positioned above the top surface of the heat activation reservoir, the heat activation reservoir configured to receive an activation agent through the access window.

20. The device of claim 19, wherein the heating element substrate further comprises a heating element cavity positioned below the test well and the control well, the heating element cavity comprising an exothermic heating material configured to generate heat when exposed to the activation agent added to the heat activation reservoir.

21. The device of claim 20, further comprising a wicking paper comprising a first portion positioned in the heat activation reservoir and a second portion positioned in the heating element cavity, the wicking paper configured to wick at least a portion of the activation agent added to the heat activation reservoir into the heating element cavity.

22. The device of claim 20, wherein the heat activating agent is air, water, a buffer, or a fluid, and wherein the exothermic heating material comprises magnesium, iron, calcium chloride, calcium oxide, sodium acetate, paraffin, a salt hydrate, a fatty acid, or combinations thereof.

23. The device of claim 1, further comprising a resistive heating element comprising a printed circuit board and an external power connector, the printed circuit board comprising a plurality of resistive heaters positioned below the reagent well, the test well, and the control well.

24. A method of detecting an analyte in a fluid sample, comprising:
applying the fluid sample to the sample reservoir of a detection device, wherein the detection device comprises:
a sample reservoir in fluid communication with a fluid flow path, wherein the fluid flow path comprises;
a control well downstream of the sample reservoir;
a valve assembly downstream of the control well;
a reagent well downstream of the valve assembly, the reagent well comprising a reducing agent dried therein; and
a test well downstream of the reagent well,
solubilizing a detection dye in the sample reservoir into the fluid sample;
propelling the fluid sample and the detection dye through the fluid flow path by coupling a cap to the sample reservoir, wherein the fluid sample and the solubilized detection dye flow sequentially to the control well, through the valve assembly, and to the reagent well; and
generating a gas in the reagent well when the analyte is present in the fluid sample, wherein the gas generated in the reagent well propels the fluid sample from the reagent well into the test well.

25. The method of claim 24, wherein the reducing agent in the reagent well reacts with the solubilized detection dye in the fluid sample in the presence of the analyte in the fluid sample, initiating a color change in the fluid sample that is detectable in the test well.

26. The method of claim 24, further comprising mixing the fluid sample and the detection dye using a mixing feature positioned in the fluid flow path downstream of the sample reservoir.

27. The method of claim 24, further comprising:
measuring a control signal at the control well;
measuring a test signal at the test well; and
indicating to a user that the analyte is not present in the fluid sample based on a determination that that the control signal and the test signal are substantially the same.

28. The method of claim 24, further comprising:
measuring a control signal at the control well;
measuring a test signal at the test well; and
indicating to a user that the analyte is present in the fluid sample based on a determination that that the control signal and the test signal are different.

29. The method of claim 28, wherein the control signal is an optical signal having a first color and the test signal is an optical signal having a second, different color, wherein the fluid sample emits the optical signal having the second, different color as a result of a reduction of the detection dye in the presence of the reducing agent and the analyte.

30. The method of claim 29, wherein the detection dye is configured the change from the first color to the second, different color in the presence of the reducing agent and the analyte.

31. The method of claim 24, wherein the reducing agent is NaBH₄.

32. The method of claim 24, wherein the fluid sample is applied to the sample reservoir in an amount of 100 to 500 μL.

33. The method of claim 24, wherein the fluid sample is applied to the sample reservoir in an amount of about 250 μL.

34. The method of claim 24, wherein the analyte is a platinum-based antineoplastic drug.

35. The method of claim 34, wherein the platinum-based antineoplastic drug comprises cisplatin, carboplatin, oxaliplatin, nedaplatin, triplatin tetranitrate, ormaplatin, phenanthriplatin, picoplatin, pyriplatin, or satraplatin, or analogues or derivatives thereof.

36. The method of claim 24, further comprising heating the reagent well and the test well with a heating element disposed below the reagent well and the test well.

37. The method of claim 36, wherein heating the reagent well and the test well comprises exposing an exothermic heating material disposed below the reagent well and the test well to a heat activating agent.

38. The method of claim 37, further comprising adding the heat activating agent to a heat activation reservoir of the detection device, and moving the heat activating agent from the heat activation reservoir to a cavity comprising the exothermic heating material.

39. The method of claim 24, further comprising obtaining or having obtained a fluid sample from a surface that is contaminated or suspected of being contaminated with the analyte.

40-94. (canceled)
